(19) United States
(12) Patent Application Publication
(10) Pub. No.: US 2012/0278560 A1
(43) Pub. Date: Nov. 1, 2012

(54) PRE-FETCHING IN A STORAGE SYSTEM THAT MAINTAINS A MAPPING TREE

(75) Inventors: Ido Benzion, Ness Ziona (IL); Efraim Zeidner, Haifa (IL); Leo Corry, Ramat Gan (IL)

(73) Assignee: INFINIDAT LTD., Herzliya (IL)

(21) Appl. No.: 13/403,032

(22) Filed: Feb. 23, 2012

Related U.S. Application Data
(63) Continuation-in-part of application No. 12/897,119, filed on Oct. 4, 2010.
Application No. 12/897,119 is a continuation-in-part of application No. PCT/IL2010/000124, filed on Feb. 11, 2010.
(60) Provisional application No. 61/248,462, filed on Oct. 4, 2009.

(51) Int. Cl. G06F 12/08

(52) U.S. Cl. 711/137; 711/E12.057

(57) ABSTRACT

A storage system, a non-transitory computer readable medium and a method for pre-fetching. The method may include presenting, by a storage system and to at least one host computer, a logical address space; determining, by a fetch module, to fetch a certain data portion from a data storage device to a cache memory of the storage system; determining, by a pre-fetch module, whether to pre-fetch at least one additional data portion from at least one data storage device to the cache memory based upon at least one characteristic of a mapping tree that maps one or more contiguous ranges of addresses related to the logical address space and one or more contiguous ranges of addresses related to the physical address space; and pre-fetching the at least one additional data portions if it is determined to pre-fetch the at least one additional data portions.

### CROSS-REFERENCES TO RELATED APPLICATIONS

This patent application is a continuation in part of U.S. patent application Ser. No. 12/897,119 filed on Oct. 4, 2010 that in turn is a continuation-in-part application of PCT application No. PCT/IL2010/000124, filed on Feb. 11, 2010 which claims priority from U.S. Provisional Patent Application No. 61/248,642 filed on Oct. 4, 2009, all being incorporated herein by reference in their entirety

### FIELD OF THE INVENTION

The present invention relates, in general, to data storage systems and respective methods for data storage, and, more particularly, to organization and management of data in data storage systems with one or more virtual layers.

### BACKGROUND OF THE INVENTION

Growing complexity of storage infrastructure requires solutions for efficient use and management of resources. Storage virtualization enables administrators to manage distributed storage as if it were a single, consolidated resource. Storage virtualization helps the storage administrator to perform the tasks of backup, archiving, and recovery more easily, and in less time, by disguising the actual complexity of the storage systems (including storage networks). Storage virtualization refers to the process of abstracting logical storage from physical storage, such abstraction may be provided at one or more layers in the storage software and hardware stack.

The virtualized system presents to the user a logical space for data storage and itself handles the process of mapping it to the actual physical location. The virtualized storage system may include modular storage arrays and a common virtualization layer enabling organization of the storage resources as a single logical pool available to users under a common management. For further fault tolerance, the storage systems may be designed as spreading data redundantly across a set of storage-nodes and enabling continuous operating when a hardware failure occurs. Fault tolerant data storage systems may store data across a plurality of disc drives and may include duplicate data, parity or other information that may be employed to reconstruct data if a drive fails. Data protection may involve a snapshot technology which enables creating a point-in-time copy of the data. Typically, snapshot copy is done instantly and made available for use by other applications such as data protection, data analysis and reporting, and data replication applications. The original copy of the data continues to be available to the applications without interruption, while the snapshot copy is used to perform other functions on the data.

The problems of mapping between logical and physical data addresses and providing snapshots in virtualized storage systems have been recognized in the Prior Art and various systems have been developed to provide a solution.

### SUMMARY OF THE INVENTION

According to an embodiment of the invention a method for pre-fetching may be provided and may include presenting, by a storage system and to at least one host computer, a logical address space; wherein the storage system may include multiple data storage devices that constitute a physical address space; wherein the storage system is coupled to the at least one host computer; determining, by a fetch module of the storage system, to fetch a certain data portion from a data storage device to a cache memory of the storage system; determining, by a pre-fetch module of the storage system, whether to pre-fetch at least one additional data portion from at least one data storage device to the cache memory based upon at least one characteristic of a mapping tree that maps one or more contiguous ranges of addresses related to the logical address space and one or more contiguous ranges of addresses related to the physical address space; and pre-fetching the at least one additional data portions if it is determined to pre-fetch the at least one additional data portions.

The determining (whether and how to pre-fetch) may be responsive to characteristic of the mapping tree that can be at least one of the following characteristics: a number of leafs in the mapping tree, a length of at least one path of the mapping tree, a variance of lengths of paths of the mapping tree, an average of lengths of paths of the mapping tree, a maximal difference between lengths of paths of the mapping tree, a number of branches in the mapping tree, a relationship between left branches and right branches of the mapping tree.

The determining (whether and how to pre-fetch) may be responsive to characteristic of the mapping tree that is a characteristic of a leaf of the mapping tree that points to a contiguous range of addresses related to the physical address space that stores the certain data portion. The characteristic of the leaf of the mapping tree can be a size of the contiguous range of addresses related to the physical address space that stores the certain data portion.

The certain data portion (that is being fetched) and each one of the at least one additional data portions (that are being pre-fetched) may be addressed within a contiguous range of addresses related to the physical address space that is represented by a single leaf of the mapping tree

The certain data portion and at least one additional data portions may be stored within different contiguous ranges of addresses related to the physical address space that are represented by different leaf of the mapping tree.

The determining (whether and how to pre-fetch) may be responsive to a characteristic of the mapping tree that is indicative of a fragmentation level of the physical address space.

The determining to pre-fetch at least one additional data portion may be made if the fragmentation level is above a fragmentation level threshold.

The determining to pre-fetch at least one additional data portion may be made if the fragmentation level is below a fragmentation level threshold.

The determining to pre-fetch at least one additional data portion may be made in response to a relationship between the fragmentation level and an expected de-fragmentation characteristic of a de-fragmentation process applied by the storage system. The expected de-fragmentation characteristic of the de-fragmentation process may be an expected frequency of the de-fragmentation process.

According to an embodiment of the invention a storage system may be provided and may include a cache memory, at least one data storage device that differs from the cache memory and constitutes a physical address space; an allocation module that is arranged to present to at least one host computer a logical address space, and to maintain a mapping tree that maps one or more contiguous ranges of addresses related to the logical address space and one or more contiguous ranges of addresses related to the physical address space; a fetch module arranged to determine to fetch a certain data portion from a data storage device to the cache memory; a pre-fetch module arranged to determine whether to pre-fetch at least one additional data portion from at least one data storage device to the cache memory based upon at least one characteristic of the mapping tree, and to pre-fetch the at least one additional data portions if it is determined to pre-fetch the at least one additional data portions.

The pre-fetch module can be arranged to perform a pre-fetch determination in response to a characteristic of the mapping tree that can be at least one of the following characteristics: a number of leafs in the mapping tree, a length of at least one path of the mapping tree, a variance of lengths of paths of the mapping tree, an average of lengths of paths of the mapping tree, a maximal difference between lengths of paths of the mapping tree, a number of branches in the mapping tree, a relationship between left branches and right branches of the mapping tree.

The pre-fetch module can be arranged to perform a pre-fetch determination in response to a characteristic of the mapping tree that is a characteristic of a leaf of the mapping tree that points to a contiguous range of addresses related to the physical address space that stores the certain data portion. The characteristic of the leaf of the mapping tree can be a size of the contiguous range of addresses related to the physical address space that stores the certain data portion.

The certain data portion (that is being fetched) and each one of the at least one additional data portions (that are being pre-fetched) may be addressed within a contiguous range of addresses related to the physical address space that is represented by a single leaf of the mapping tree

The certain data portion and at least one additional data portions may be stored within different contiguous ranges of addresses related to the physical address space that are represented by different leaf of the mapping tree.

The pre-fetch module can be arranged to perform a pre-fetch determination in response to a characteristic of the mapping tree that is indicative of a fragmentation level of the physical address space.

The pre-fetch module can be arranged to determine to pre-fetch at least one additional data portion if the fragmentation level is above a fragmentation level threshold.

The pre-fetch module can be arranged to determine to pre-fetch at least one additional data portion if the fragmentation level is below a fragmentation level threshold.

The pre-fetch module can be arranged to determine to pre-fetch at least one additional data portion in response to a relationship between the fragmentation level and an expected de-fragmentation characteristic of a de-fragmentation process applied by the storage system. The expected de-fragmentation characteristic of the de-fragmentation process may be an expected frequency of the de-fragmentation process.

According to an embodiment of the invention a non-transitory computer readable medium can be provided and may store instructions for presenting to at least one host computer a logical address space; wherein the at least one host computers are coupled to a storage system that may include multiple data storage devices that constitute a physical address space; determining to fetch a certain data portion from a data storage device to a cache memory of the storage system; determining whether to pre-fetch at least one additional data portion from at least one data storage device to the cache memory based upon at least one characteristic of a mapping tree that maps one or more contiguous ranges of addresses related to the logical address space and one or more contiguous ranges of addresses related to the physical address space; and pre-fetching the at least one additional data portions if it is determined to pre-fetch the at least one additional data portions.

The non-transitory computer readable medium can store instructions for executing any of the stages or any combination of stages of any method described in this specification.

According to an embodiment of the invention a storage system may be provided and may include a plurality of storage control devices constituting a control layer; a plurality of physical storage devices constituting a physical storage space; the plurality of physical storage devices are arranged to be controlled by the plurality of storage control devices; wherein the control layer is coupled to a plurality of hosts; wherein the control layer is operable to handle a logical address space divided into one or more logical groups and available to said plurality of hosts; wherein the control layer further may include an allocation module configured to provide mapping between one or more contiguous ranges of addresses related to the logical address space and one or more contiguous ranges of addresses related to the physical address space, said mapping provided with the help of one or more mapping trees, each tree assigned to a separate logical group in the logical address space; wherein the one or more mapping trees further may include timing information indicative of timings of accesses to the contiguous ranges of addresses related to the physical address space.

According to an embodiment of the invention a method may be provided and may include representing, by a storage system to a plurality of hosts, an available logical address space divided into one or more logical groups; the storage system includes a plurality of physical storage devices controlled by a plurality of storage control devices constituting a control layer; the control layer operatively coupled to the plurality of hosts and to the plurality of physical storage devices constituting a physical storage space; mapping between one or more contiguous ranges of addresses related to the logical address space and one or more contiguous ranges of addresses related to the physical address space, the mapping is provided with the help of one or more mapping trees, each tree assigned to a separate logical group in the logical address space; and updating the one or more mapping trees with timing information indicative of timings of accesses to the contiguous ranges of addresses related to the physical address space.

According to an embodiment of the invention a non-transitory computer readable medium may store instructions for representing to a plurality of hosts an available logical address space divided into one or more logical groups; the storage system includes a plurality of physical storage devices controlled by a plurality of storage control devices constituting a control layer; the control layer operatively coupled to the plurality of hosts and to the plurality of physical storage devices constituting a physical storage space; mapping between one or more contiguous ranges of addresses related to the logical address space and one or more contiguous ranges of addresses related to the physical address space, the mapping is provided with the help of one or more mapping trees, each tree assigned to a separate logical group in the logical address space; and updating the one or more mapping trees with timing information indicative of timings of accesses to the contiguous ranges of addresses related to the physical address space.

### BRIEF DESCRIPTION OF THE DRAWINGS

In order to understand the invention and to see how it can be carried out in practice, embodiments will now be described, by way of non-limiting example only, with reference to the accompanying drawings, in which:

FIG. 1 illustrates a schematic functional block diagram of a computer system with virtualized storage system as known in the art;

FIG. 2 illustrates a schematic functional block diagram of a control layer configured in accordance with certain embodiments of the present invention;

FIG. 3 illustrates a schematic diagram of physical storage space configured in RAID group as known in the art.

FIG. 4 illustrates a schematic diagram of representing exemplified logical volumes in the virtual layers in accordance with certain embodiments of the present invention; and

FIG. 5 illustrates a schematic diagram of IVAS and PVAS Allocation Tables in accordance with certain embodiments of the present invention;

FIGS. 6a-6c schematically illustrate an exemplary mapping of addresses related to logical volumes into addresses related to physical storage space in accordance with certain embodiments of the present invention;

FIGS. 7a-7d schematically illustrate other exemplary mapping of addresses related to logical volumes into addresses related to physical storage space in accordance with certain embodiments of the present invention;

FIGS. 8a-8c schematically illustrate exemplary mapping, in accordance with certain embodiments of the present invention, a range of previously allocated addresses related to logical volumes responsive to modification by a write request;

FIG. 9a-9b schematically illustrate exemplary mapping a range of contiguous VUA addresses to more than one corresponding ranges of VDA addresses, in accordance with certain embodiments of the present invention; and

FIG. 10a-10c schematically illustrate exemplary mapping a logical volume and corresponding generated snapshot(s) in accordance with certain embodiments of the present invention.

FIG. 11 illustrates a method for pre-fetching according to an embodiment of the invention;

FIG. 12 illustrates a storage system and its environment according to an embodiment of the invention;

FIG. 13 illustrates a mapping tree according to an embodiment of the invention; and

FIG. 14 illustrates a method according to an embodiment of the invention.

### DETAILED DESCRIPTION OF EMBODIMENTS

In the following detailed description, numerous specific details are set forth in order to provide a thorough understanding of the invention. However, it will be understood by those skilled in the art that the present invention can be practiced without these specific details. In other instances, well-known methods, procedures, components and circuits have not been described in detail so as not to obscure the present invention. In the drawings and descriptions, identical reference numerals indicate those components that are common to different embodiments or configurations.

Unless specifically stated otherwise, as apparent from the following discussions, it is appreciated that throughout the specification discussions utilizing terms such as “processing”, “computing”, “calculating”, “determining”, “generating”, “activating”, “reading”, “writing”, “classifying”, “allocating”, “storing”, “managing” or the like, refer to the action and/or processes of a computer that manipulate and/or transform data into other data, said data represented as physical, such as electronic, quantities and/or said data represent the physical objects. The term “computer” should be expansively construed to cover any kind of electronic system with data processing capabilities.

The operations in accordance with the teachings herein can be performed by a computer specially constructed for the desired purposes or by a general-purpose computer specially configured for the desired purpose by a computer program stored in a computer readable storage medium.

Embodiments of the present invention are not described with reference to any particular programming language. It will be appreciated that a variety of programming languages can be used to implement the teachings of the inventions as described herein.

The references cited in the background teach many principles of storage virtualization that are applicable to the present invention. Therefore the full contents of these publications are incorporated by reference herein for appropriate teachings of additional or alternative details, features and/or technical background.

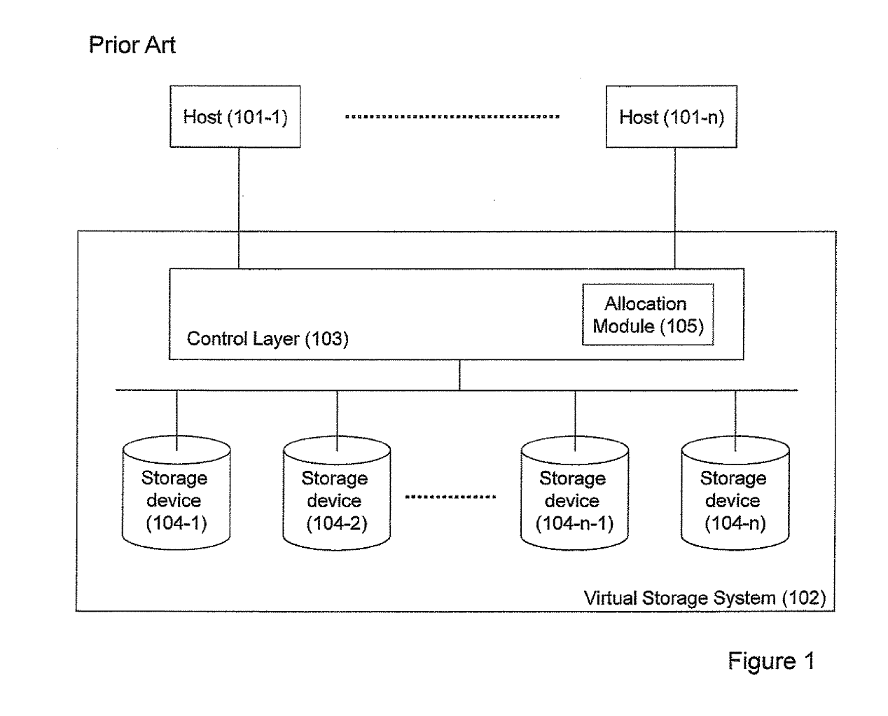

Bearing this in mind, attention is drawn to FIG. 1 illustrating an exemplary virtualized storage system as known in the art.

The computer system comprises a plurality of host computers (workstations, application servers, etc.) illustrated as 101-1-101-n sharing common storage means provided by a virtualized storage system 102. The storage system comprises a storage control layer 103 comprising one or more appropriate storage control devices operatively coupled to the plurality of host computers and a plurality of data storage devices 104-1-104-n constituting a physical storage space optionally distributed over one or more storage nodes, wherein the storage control layer is operable to control interface operations (including I/O operations) therebetween. The storage control layer is further operable to handle a virtual representation of physical storage space and to facilitate necessary mapping between the physical storage space and its virtual representation. The virtualization functions can be provided in hardware, software, firmware or any suitable combination thereof. Optionally, the functions of the control layer can be fully or partly integrated with one or more host computers and/or storage devices and/or with one or more communication devices enabling communication between the hosts and the storage devices. Optionally, a format of logical representation provided by the control layer may differ, depending on interfacing applications.

The physical storage space can comprise any appropriate permanent storage medium and include, by way of non-limiting example, one or more disk drives and/or one or more disk units (DUs). The physical storage space comprises a plurality of data blocks, each data block can be characterized by a pair (DD.sub.id, DBA), and where DD.sub.id is a serial number associated with the disk drive accommodating the data block, and DBA is a logical block number within the respective disk. By way of non-limiting example, DD.sub.id can represent a serial number internally assigned to the disk drive by the system or, alternatively, a WWN or universal serial number assigned to the disk drive by a vendor. The storage control layer and the storage devices can communicate with the host computers and within the storage system in accordance with any appropriate storage protocol.

Stored data can be logically represented to a client in terms of logical objects. Depending on storage protocol, the logical objects can be logical volumes, data files, multimedia files, snapshots and other copies, etc. For purpose of illustration only, the following description is provided with respect to logical objects represented by logical volumes. Those skilled in the art will readily appreciate that the teachings of the present invention are applicable in a similar manner to other logical objects.

A logical volume (LU) is a virtual entity logically presented to a client as a single virtual storage device. The logical volume represents a plurality of data blocks characterized by successive Logical Block Addresses (LBA) ranging from 0 to a number LUK. Different LUs can comprise different numbers of data blocks, while the data blocks are typically of equal size (e.g. 512 bytes). Blocks with successive LBAs can be grouped into portions that act as basic units for data handling and organization within the system. Thus, for instance, whenever space has to be allocated on a disk or on a memory component in order to store data, this allocation can be done in terms of data portions also referred to hereinafter as “allocation units”. Data portions are typically of equal size throughout the system (by way of non-limiting example, the size of data portion can be 64 Kbytes).

The storage control layer can be further configured to facilitate various protection schemes. By way of non-limiting example, data storage formats, such as RAID (Redundant Array of Independent Discs), can be employed to protect data from internal component failures by making copies of data and rebuilding lost or damaged data. As the likelihood for two concurrent failures increases with the growth of disk array sizes and increasing disk densities, data protection can be implemented, by way of non-limiting example, with the RAID 6 data protection scheme well known in the art.
Common to all RAID 6 protection schemes is the use of two parity data portions per several data groups (e.g. using groups of four data portions plus two parity portions in (4+2) protection scheme), the two parities being typically calculated by two different methods. Under one known approach, all n consecutive data portions are gathered to form a RAID group, to which two parity portions are associated. The members of a group as well as their parity portions are typically stored in separate drives. Under a second known approach, protection groups can be arranged as two-dimensional arrays, typically n*n, such that data portions in a given line or column of the array are stored in separate disk drive's. In addition, to every row and to every column of the array a parity data portion can be associated.

These parity portions are stored in such a way that the parity portion associated with a given column or row in the array resides in a disk drive where no other data portion of the same column or row also resides. Under both approaches, whenever data is written to a data portion in a group, the parity portions are also updated (e.g. using approaches based on XOR or Reed-Solomon algorithms). Whenever a data portion in a group becomes unavailable (e.g. because of disk drive general malfunction, or because of a local problem affecting the portion alone, or because of other reasons), the data can still be recovered with the help of one parity portion via appropriate known in the art techniques. Then, if a second malfunction causes data unavailability in the same drive before the first problem was repaired, data can nevertheless be recovered using the second parity portion and appropriate known in the art techniques.

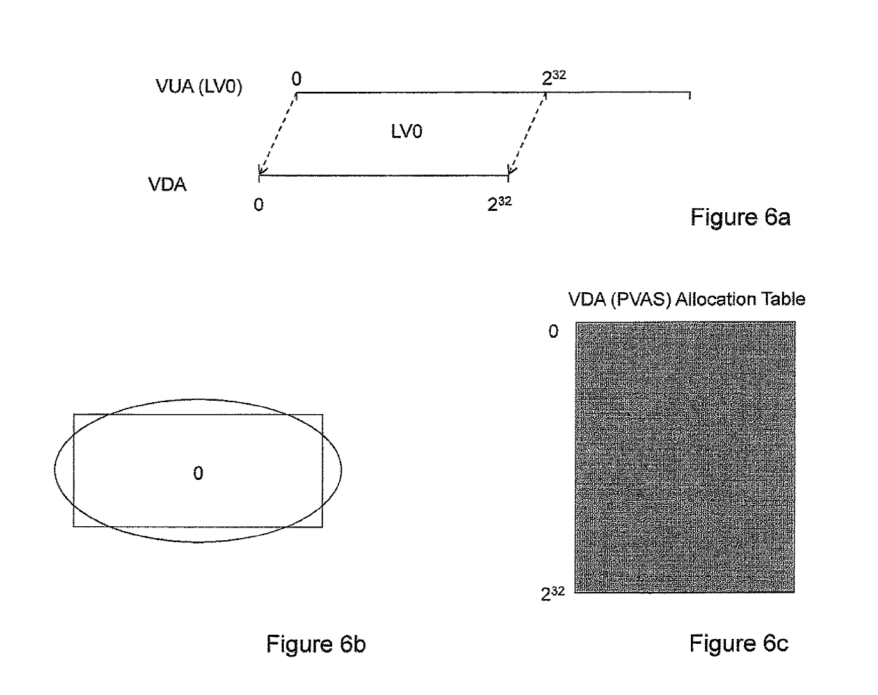

Successive data portions constituting a logical volume are typically stored in different disk drives (e.g. for purposes of both performance and data protection), and to the extent that it is possible, across different DUs. Typically, definition of LUs in the storage system involves in-advance configuring an allocation scheme and/or allocation function used to determine the location of the various data portions and their associated parity portions across the physical storage medium. Logical contiguity of successive portions and physical contiguity of the storage location allocated to the portions in the system are not necessarily correlated. The allocation scheme can be handled in an allocation module (105) being a part of the storage control layer. The allocation module can be implemented as a centralized module operatively connected to the plurality of storage control devices or can be, at least partly, distributed over a part or all storage control devices. The allocation module can be configured to provide mapping between logical and physical locations of data portions and/or groups thereof with the help of a mapping tree as further detailed with reference to FIGS. 6-10.

When receiving a write request from a host, the storage control layer defines a physical location(s) designated for writing the respective data (e.g. in accordance with an allocation scheme, preconfigured rules and policies stored in the allocation module or otherwise). When receiving a read request from the host, the storage control layer defines the physical location(s) of the desired data and further processes the request accordingly. Similarly, the storage control layer issues updates to a given data object to all storage nodes which physically store data related to the data object. The storage control layer is further operable to redirect the request/update to storage device(s) with appropriate storage location(s) irrespective of the specific storage control device receiving I/O request.

For purpose of illustration only, the operation of the storage system is described herein in terms of entire data portions. Those skilled in the art will readily appreciate that the teachings of the present invention are applicable in a similar manner to partial data portions.

Certain embodiments of the present invention are applicable to the architecture of a computer system described with reference to FIG. 1. However, the invention is not bound by the specific architecture, equivalent and/or modified functionality can be consolidated or divided in another manner and can be implemented in any appropriate combination of software, firmware and hardware.

Those versed in the art will readily appreciate that the invention is, likewise, applicable to any computer system and any storage architecture implementing a virtualized storage system. In different embodiments of the invention the functional blocks and/or parts thereof can be placed in a single or in multiple geographical locations (including duplication for high-availability); operative connections between the blocks and/or within the blocks can be implemented directly (e.g. via a bus) or indirectly, including remote connection. The remote connection can be provided via Wire-line, Wireless, cable, Internet, Intranet, power, satellite or other networks and/or using any appropriate communication standard, system and/or protocol and variants or evolution thereof (as, by way of unlimited example, Ethernet, iSCSI, Fiber Channel, etc.). By way of non-limiting example, the invention can be implemented in a SAS grid storage system disclosed in U.S. patent application Ser. No. 12/544,743 filed on Aug. 20, 2009, assigned to the assignee of the present application and incorporated herein by reference in its entirety.

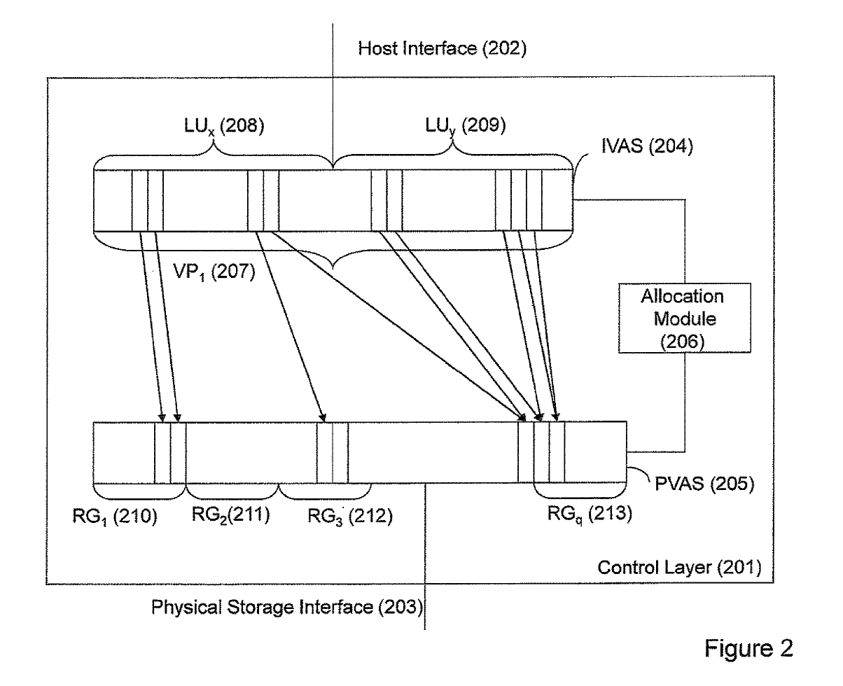

Referring to FIG. 2, there is schematically illustrated control layer 201 configured in accordance with certain embodiments of the present invention. The virtual presentation of entire physical storage space is provided through creation and management of at least two interconnected virtualization layers: a first virtual layer 204 interfacing via a host interface 202 with elements of the computer system (host computers, etc.) external to the storage system, and a second virtual layer 205 interfacing with the physical storage space via a physical storage interface 203. The first virtual layer 204 is operative to represent logical units available to clients (workstations, applications servers, etc.) and is characterized by an Internal Virtual Address Space (IVAS). The virtual data blocks are represented in IVAS with the help of virtual unit address (VUA). The second virtual layer 205 is operative to represent physical storage space available to the clients and is characterized by a Physical Virtual Address Space (PVAS). The virtual data blocks are represented in PVAS with the help of a virtual disk address (VDA). Addresses in IVAS are mapped into addresses in PVAS; while addresses in PVAS, in turn, are mapped into addresses in physical storage space for the stored data. The first virtual layer and the second virtual layer are interconnected, e.g. with the help of the allocation module 206 operative to provide translation from IVAS to PVAS via Internal-to-Physical Virtual Address Mapping. The allocation module 206 can be configured to provide mapping between VUAs and VDAs with the help of a mapping tree as further detailed with reference to FIGS. 6-10.

Each address in the Physical Virtual Address Space has at least one corresponding address in the Internal Virtual Address Space. Managing the Internal Virtual Address Space and Physical Virtual Address Space is provided independently. Such management can be provided with the help of an independently managed IVAS allocation table and a PVAS allocation table. The tables can be accommodated in the allocation module 206 or otherwise, and each table facilitates management of respective space in any appropriate way known in the art.

Among advantages of independent management of IVAS and PVAS is the ability of changing a client's side configuration of the storage system (e.g. new host connections, new snapshot generations, changes in status of exported volumes, etc.), with no changes in meta-data handled in the second virtual layer and/or physical storage space.

It should be noted that, typically in the virtualized storage system, the range of virtual addresses is substantially larger than the respective range of associated physical storage blocks. In accordance with certain embodiments of the present invention, the internal virtual address space (IVAS) characterizing the first virtual layer corresponds to a plurality of logical addresses available to clients in terms of LBAs of LUs. Respective LUs are mapped to IVAS via assignment of IVAS addresses (VUA) to the data portions constituting the LUs and currently available to the client.

By way of non-limiting example, FIG. 2 illustrates a part of the storage control layer corresponding to two LUs illustrated as LUx (208) and LUy (209). The LUs are mapped into the IVAS. In a typical case, initially the storage system assigns to a LU contiguous addresses (VUAs) in IVAS. However, existing LUs can be enlarged, reduced or deleted, and some new ones can be defined during the lifetime of the system. Accordingly, the range of contiguous data blocks associated with the LU can correspond to non-contiguous data blocks assigned in the IVAS.

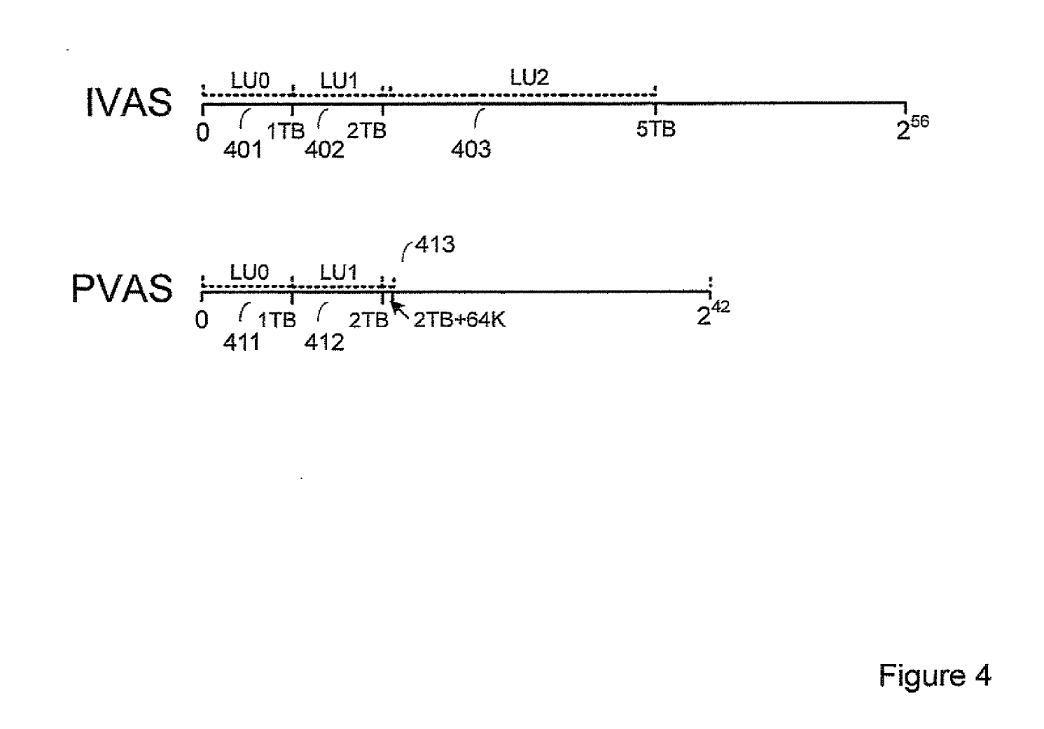

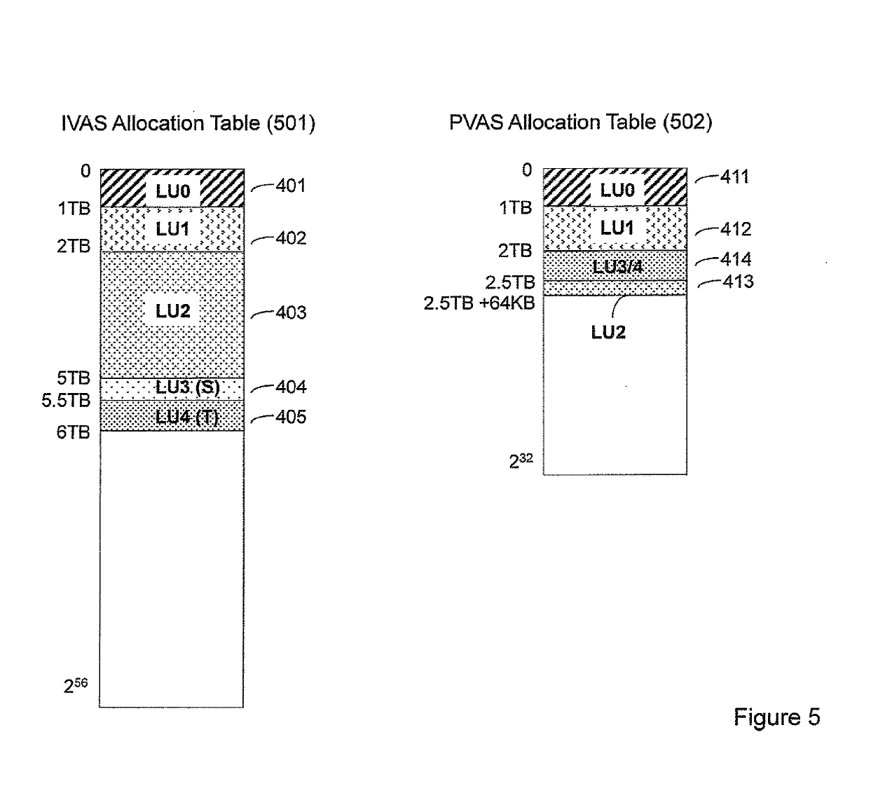

As will be further detailed with reference to FIGS. 4 and 5, the parameters defining the request in terms of IVAS are further translated into parameters defining the request in the physical virtual address space (PVAS) characterizing the second virtual layer interconnected with the first virtual layer.

Responsive to configuring a logical volume (regular LU, thin volume, snapshot, etc.), the storage system allocates respective addresses in IVAS. For regular LUs the storage system further allocates corresponding addresses in PVAS, wherein allocation of physical addresses is provided responsive to a request to write the respective LU. Optionally, the PVAS allocation table can book the space required for LU and account it as unavailable, while actual address allocation in PVAS is provided responsive to respective write request.

As illustrated in FIG. 2, translation of a request in terms of IVAS into request in PVAS terms is not necessarily provided in a one-to-one relationship. In accordance with certain embodiments of the invention, several data blocks in the IVAS can correspond to one and the same data block in the PVAS, as for example in a case of snapshots and/or other copy mechanisms which can be implemented in the storage system. By way of non-limiting example, in the case of a snapshot, a source block and a target block in respective snapshot are presented to clients as having different addresses in the IVAS, but they share the same block in the PVAS until the source block (or the target block) is modified for the first time by a write request, at which point two different physical data blocks are produced.

By way of another non-limiting example, in a case of thin volume, each block of the LU is immediately translated into a block in the IVAS, but the association with a block in the PVAS is provided only when actual physical allocation occurs, i.e., only on the first write to corresponding physical block. In the case of thin volume the storage system does not provide booking of available space in PVAS. Thus, in contrast to a regular volume, thin volumes have no guaranteed available space in PVAS and physical storage space.

The Internal Virtual Address Space (IVAS) characterizing the first virtual layer 204 representing available logical storage space comprises virtual internal addresses (VUAs) ranging from 0 to 2.sup.M, where M is the number of bits used to express in binary terms the addresses in the IVAS (by way of non-limiting example, in further description we refer to M=56 corresponding to 64-bit address field). Typically, the range of virtual addresses in the IVAS needs to be significantly larger than the range of physical virtual addresses (VDAs) of the Physical Virtual Address Space (PVAS), characterizing the second virtual layer 205 representing available physical storage space.

Usually, in mass storage systems a certain part of the overall physical storage space is defined as not available to a client, so it can be used as a spare space in case of necessity or for other purposes. Accordingly, the entire range of physical virtual addresses (VDAs) in PVAS can correspond to a certain portion (e.g. 70-80%) of the total physical storage space available on the disk drives. By way of non-limiting example, if a system with raw physical capacity of 160 TB with 30% of this space allocated for spare purposes is considered, then the net capacity will be 113 TB. Therefore, the highest possible address VDA that can be assigned in the PVAS of such a system is about 242 (2.sup.42.about.113*10.sup.12), which is substantially less than the entire range of 2.sup.56 addresses VUA in the IVAS.

As will be further detailed with reference to FIGS. 4-5, at any given point in time, there can be several data blocks in the IVAS corresponding to one data block in the PVAS. Moreover, a significant amount of data blocks in the IVAS can be initially provided to a client without associating with any block in the PVAS, with later association with PVAS only upon actual physical allocation, if at all. The storage control layer can be further virtualized with the help of one or more virtual partitions (VPs).

By way of non-limiting example, FIG. 2 illustrates only a part of the storage control layer corresponding to a virtual partition VP.sub.1 (207) selected among the plurality of VPs corresponding to the control layer. The VP.sub.1 (207) comprises several LUs illustrated as LUx (208) and LUy (209). The LUs are mapped into the IVAS. The storage control layer translates a received request (LUN, LBA, block_count) into requests (VPid, VUA, block_count) defined in the IVAS. In a typical case, initially the storage system assigns to a LU contiguous addresses (VUAs) in the IVAS. However, existing LUs can be enlarged, reduced or deleted, and some new ones can be defined during the lifetime of the system. Accordingly, the range of contiguous data blocks associated with the LU can correspond to non-contiguous data blocks assigned in the IVAS: (VPid, VUA1, block_count1), (VPid, VUA2, block_count2), etc. Unless specifically stated otherwise, referring to hereinafter the parameter (VPid, VUA, block_count) can also include referring to the two or more parameters (VPid, VUA.sub.i, block_count.sub.i).

In accordance with certain embodiments of the present invention, the parameters (VPid, VUA, block_count) that define the request in IVAS are further translated into (VPid, VDA, block_count) defining the request in the physical virtual address space (PVAS) characterizing the second virtual layer interconnected with the first virtual layer.

For purpose of illustration only, the following description is made with respect to RAID 6 architecture. Those skilled in the art will readily appreciate that the teachings 1.COPYRGT. of the present invention are not bound by RAID 6 and are applicable in a similar manner to other RAID technology in a variety of implementations and form factors.

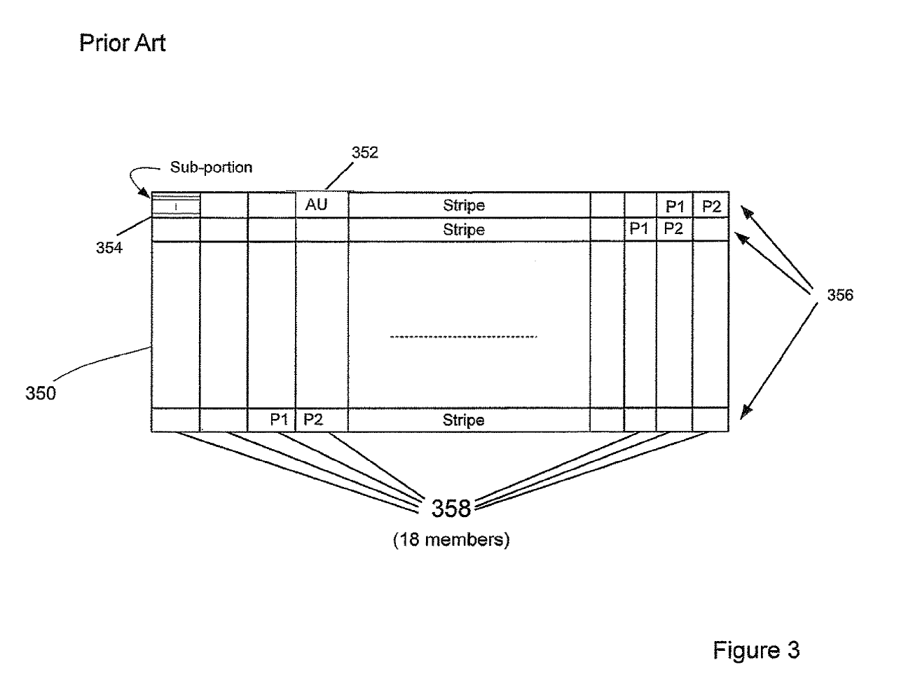

The physical storage space can be configured as RAID groups concatenation as further illustrated in FIG. 3. Accordingly, as illustrated in FIG. 2, the second virtual layer 205 representing the physical storage space can be also configured as a concatenation of RAID Groups (RGs) illustrated as RG.sub.1 (210) to RGq (213). Each RAID group comprises a set of contiguous data blocks, and the address of each such block can be identified as (RGid, RBA), by reference to the RAID group RGid and a RAID logical block number RBA within the group.

Referring to FIG. 3, there is illustrated a schematic diagram of physical storage space configured in RAID groups as known in the art. A RAID group (350) can be built as a concatenation of stripes (356), the stripe being a complete (connected) set of data and parity elements that are dependently related by parity computation relations. In other words, the stripe is the unit within which the RAID write and recovery algorithms are performed in the system. A stripe comprises N+2 data portions (352), the data portions being the intersection of a stripe with a member (356) of the RAID group. A typical size of the data portions is 64 KByte (or 128 blocks). Each data portion is further sub-divided into 16 sub-portions (354) each of 4 Kbyte (or 8 blocks). Data portions and sub-portions are used to calculate the two parity data portions associated with each stripe. In an example, with N=16, and with a typical size of 4 GB for each group member, the RAID group can typically comprise (4*16=) 64 GB of data. A typical size of the RAID group, including the parity blocks, can be of (4*18=) 72 GB.

Each RG comprises n+2 members, MEMi (0.ltoreq.i.ltoreq.n+1), with n being the number of data portions per RG (e.g. n=16). The storage system is configured to allocate data associated with the RAID groups over various physical drives. The physical drives need not be identical. For purposes of allocation, each PD can be divided into successive logical drives (LDs). The allocation scheme can be accommodated in the allocation module.

Referring to FIG. 4, there is schematically illustrated translation from IVAS to PVAS in accordance with certain embodiments of the present invention.

As has been detailed with reference to FIG. 2, IO requests are handled at the level of the PVAS in terms of (VPid, VDA, block_count). As PVAS represents concatenation of RGs, such requests can be further translated in terms of the relevant RAID groups as (RGid, RBA, block_count) and from there in terms of physical address on the disks, as (DDid, DBA, block_count), assigned to the RAID groups in accordance with an allocation scheme. However, the translation is provided still at the PVAS level, wherein the actual allocation of physical storage space for a certain RAID group is provided responsive to an arriving first write request directed to this group. A Utilization Bitmap of the physical storage space indicates which RAID groups have already been allocated.

It should also be noted that certain additional data protection mechanisms (as, for example, “Data Integrity Field” (DIF) or similar ones) handled only at a host and at the RAID group, can be passed transparently over the virtualization layers.

The schematic diagram in FIG. 4 illustrates representing exemplified logical volumes in the virtual layers in accordance with certain embodiments of the present invention. In the illustrated case the user has defined two logical volumes LU0, LU1, each of 1 TB size, and logical volume LU2 of 3 TB size. The logical volumes have been respectively mapped in IVAS as ranges 401, 402 and 403. The IVAS allocation table (illustrated in FIG. 5) is updated accordingly.

Logical Volumes LU0 and LU1 have been configured as regular volumes, while the logical volume LU2 has been configured as a thin logical device (or dynamically allocated logical device). Accordingly, ranges 401 and 402 in IVAS have been provided with respective allocated 1 TB ranges 411 and 412 in PVAS, while no allocation has been provided in PVAS with respect to the range 403. As will be further detailed in connection with Request 3, allocation 413 in PVAS for LU2 will be provided responsive to respective write requests. PVAS allocation table (illustrated in FIG. 5) is updated accordingly upon allocation of ranges 411 and 412, and upon respective writes corresponding to LU2.

FIG. 5 schematically illustrates IVAS and PVAS Allocation Tables for exemplified logical volumes. Further to the example illustrated in FIG. 4, in the case illustrated in

FIG. 5 the user has defined logical volume LU3 of 0.5 TB size and then has generated a snapshot of LU3, here defined as logical volume LU4 (with the same size). Accordingly, IVAS allocation table illustrates allocations of respective ranges 401-405 in IVAS. Ranges 401 and 402 have corresponding ranges 411 and 412 allocated in the PVAS allocation table. Ranges 404 and 405 in IVAS correspond to a common range 414 allocated in PVAS. The source volume LU3 and the target volume LU4 of the respective snapshot are presented to clients as having different addresses in the IVAS (404 and 405 respectively), but they share the same addresses (414) in the PVAS until the source or the target is modified for the first time by a write request, at which point a respective new range will be allocated in PVAS.

Allocation 413 for LU2 is provided in the PVAS allocation table upon receiving respective write request (in the illustrated case after allocation of 414). Responsive to further write requests, further allocations for LU2 can be provided at respectively available addresses with no need of in-advance reservations in PVAS. Hence, the total space allocated for volumes LU0-LU4 in IVAS is 6 TB, and respective space allocated in PVAS is 2.5 TB+64 KB.

Table 1 illustrates non-limiting examples of JO requests to the above exemplified logical volumes in terms of host and the virtualization layers. For simplicity the requests are described without indicating VPs to which they can be directed.

TABLE 1

| | Host Level | IVAS Level | PVAS Level |
|---|---|---|---|
| Request 1 | (LU0, 200 GB, | (200 GB, 100 GB) | (200 GB, 100 GB) |
| | 100 GB) | | |
| Request 2 | (LU1, 200 GB, | (1 TB + 200 GB, | (1 TB + 200 GB, |
| | 100 GB) | 100 GB) | 100 GB) |
| Request 3 | (LU1, 400 GB, | (1 TB + 400 GB, | (1 TB + 400 GB, |
| | 50 GB) | 50 GB) | 50 GB) |
| Request 4 | (LU2, 0, 64 KB) | (2 TB + 0, 64 KB) | (2 TB + 0, 64 KB) |

Request 1 is issued by a host as a request to LU0. Its initial offset within the LU0 is 200 GB, and its length is 100 GB. Since LU0 starts in the IVAS at offset 0, the request is translated in IVAS terms as a request to offset 0+200 GB, with length 100 GB. With the help of Internal-to-Physical Virtual Address Mapping the request is translated in terms of PVAS as a request starting at offset 0+200 (0 being the offset representing in the PVAS offset 0 of the IVAS), and with length 100 GB. Similarly, Request 2 is issued by a host as a request to LU1. Its initial offset within the LU1 is 200 GB, and its length is 100 GB. Since LU1 starts in the IVAS at offset 1 TB, the request is translated in IVAS terms as a request to offset 1 TB+200 GB, with length 100 GB. With the help of Internal-to-Physical Virtual Address Mapping this request is translated in terms of PVAS as a request starting at 1 TB+200 GB (1 TB being the offset representing in the PVAS offset 1 TB of the IVAS), and with length 100 GB.

Request 3 is issued by a host as a first writing request to LU2 to write 64K of data at offset 0. As LU2 is configured as a thin volume, it is represented in IVAS by the address range 2 TB-5 TB, but has no pre-allocation in PVAS. Since LU2 starts in the IVAS at offset 2 TB, the request is translated in IVAS terms as a request to offset 2 TB+0, with length 64 KB. As there were no pre-allocations to LU2 in PVAS, the allocation module checks available PVAS address in PVAS allocation table (2.5 TB in the illustrated case) and translates the request in terms of PVAS as a request starting at 0+2.5 TB and with length 64 KB.

Request 4 is issued by a host as a read request to LU3 (source volume) to read 100 GB of data at offset 50 G. Since LU3 starts in the IVAS at offset 5 TB, the request is translated in IVAS terms as a request to offset 5 TB+50 GB, with length 100 GB. With the help of Internal-to-Physical Virtual Address Mapping this request is translated in terms of PVAS as a request starting at 2 TB+50 GB (2 TB being the offset representing in the PVAS offset 2 TB of the IVAS), and with length 100 GB. Request 5 is issued by a host as a read request to LU4 (target volume) to read 50 GB of data at offset 10 G. Since LU4 starts in the IVAS at offset 5.5 TB, the request is translated in IVAS terms as a request to offset 5.5 TB+10 GB, with length 50 GB. With the help of Internal-to-Physical Virtual Address Mapping this request is translated in terms of PVAS as a request starting at 2 TB+10 GB (2 TB being the offset representing in the PVAS offset 2 TB of the IVAS), and with length 50 GB.

It should be noted that Request 4 and Request 5 directed to a source and a target (snapshot) volumes correspond to different ranges (404 and 405) in IVAS, but to the same range in PVAS (until LU3 or LU4 are first modified and are provided by a correspondent allocation in PVAS).

It should be also noted that, as illustrated, the requests handled at IVAS and PVAS levels do not comprise any reference to logical volumes requested by hosts. Accordingly, the control layer configured in accordance with certain embodiments of the present invention enables to handle, in a uniform manner, various logical objects (LUs, files, etc.) requested by hosts, thus facilitating simultaneous support of various storage protocols. The first virtual layer interfacing with clients is configured to provide necessary translation of IO requests, while the second virtual layer and the physical storage space are configured to operate in a protocol-independent manner.

Accordingly, in a case of further virtualization with the help of virtual partitions, each virtual partition can be adapted to operate in accordance with its own protocol (e.g. SAN, NAS, OAS, CAS, etc.) independently from protocols used by other partitions.

The control layer configured in accordance with certain embodiments of the present invention further facilitates independent configuring protection of each virtual partition. Protection for each virtual machine can be configured independently from other partitions in accordance with individual protection schemes (e.g. RAID1, RAID5, RAID6, etc.) The protection scheme of certain VP can be changed with no need in changes at the client's side configuration of the storage system.

By way of non-limiting example, the control layer can be divided into six virtual partitions so that VP0 and VP3 use RAID1, VP1 and VP4 use RAID 5, and VP2 and VP6 use RAID 6 protection schemes. All RGs of the certain VP are handled according to the stipulated protection level. When configuring a LU, a user is allowed to select a protection scheme to be used, and to assign the LU to a VP that provides that level of protection. The distribution of system resources (e.g. physical storage space) between the virtual partitions can be predefined (e.g. equally for each VP). Alternatively, the storage system can be configured to account the disk space already assigned for use by the allocated RGs and, responsive to configuring a new LU, to check if available resources for accepting the volume exist, in accordance with the required protection scheme. If the available resources are insufficient for the required protection scheme, the system can provide a respective alert. Thus, certain embodiments of the present invention enable dynamic allocation of resources required for protecting different VPs.

Referring back to FIG. 5, the IVAS and PVAS Allocation Tables can be handled as independent linked lists of used ranges. The tables can be used for deleting LUs and de-allocating the respective space. For example, deleting LU 1 requires indicating in the IVAS Allocation Table that ranges 0-1 TB and 2-6 TB are allocated, and the rest is free, and at the same time indicating in the PVAS Allocation Table that ranges 0-1 TB and 2-2.5 TB+64 KB are allocated, and the rest is free.

Deleting LU3, requires indicating in the IVAS Allocation Table that ranges 0-5 TB and 5.5-6 TB are allocated, and the rest is free, while the PVAS Allocation Table will remain unchanged.

In certain embodiments of the present invention, deleting a logical volume can be done by combining two separate processes: an atomic process (that performs changes in the IVAS and its allocation table) and a background process (that performs changes in the PVAS and its allocation table). Atomic deletion process is a “zero-time” process enabling deleting the range allocated to the LU in the IVAS Allocation Table. The LU number can remain in the table but there is no range of addresses associated with it. This means that the volume is not active, and an IO request addressed at it cannot be processed. The respective range of IVAS addresses is de-allocated and it is readily available for new allocations. Background deletion process is a process which can be performed gradually in the background in accordance with preference levels determined by the storage system in consideration of various parameters. The process scans the PVAS in order to de-allocate all ranges corresponding to the ranges deleted in the IVAS Allocation Table during the corresponding atomic process, while updating Utilization Bitmap of the physical storage space if necessary. Likewise, during this background process, the Internal-to-Physical Virtual Address Mapping is updated, so as to eliminate all references to the IVAS and PVAS just de-allocated.

If an LU comprises more than one range of contiguous addresses in IVAS, the above combination of processes is provided for each range of contiguous addresses in IVAS.

As was illustrated with reference to FIG. 5, the IVAS-based step of deleting process can be provided without the PVAS-based step. For example, a non-allocated at physical level snapshot or thin volume can be deleted from IVAS, with no need in any changes in PVAS and/or physical storage space, as there were no respective allocations.

In accordance with certain embodiments of the invention, there is further provided a functionality of “virtual deleting” of a logical volume defined in the system. When a user issues a “virtual deleting” for a given LU in the system, the system can perform the atomic phase of the deletion process (as described above) for that LU, so that the LU is de-allocated from the IVAS and is made unavailable to clients. However, the background deletion process is delayed, so that the allocations in IVAS and PVAS (and, accordingly, physical space) and the Internal-to-Physical Virtual Address Mapping are kept temporarily unchanged. Accordingly, as long as the background process is not effective, the user can instantly un-delete the virtually deleted LU, by just re-configuring the respective LU in IVAS as “undeleted”. Likewise, the “virtual deleting” can be implemented for snapshots and other logical objects.

The metadata characterizing the allocations in IVAS and PVAS can be kept in the system in accordance with pre-defined policies. Thus, for instance, the system can be adapted to perform the background deletion process (as described above) 24 hours after the atomic phase was completed for the LU. In certain embodiments of the invention the period of time established for initiating the background deletion process can be adapted to different types of clients (e.g. longer times for VIP users, longer types for VIP applications, etc.). Likewise, the period can be dynamically adapted for individual volumes or be system-wide, according to availability of resources in the storage system, etc.

As will be further detailed with reference to FIGS. 6-10, mapping between addresses related to logical address space and addresses related to physical storage space may be provided with the help of a mapping tree(s) configured in accordance with certain embodiments of the present invention. The mapping trees may be handled by the allocation module. The mapping trees are further associated with an allocation table indicating allocated and free addresses in the physical storage space. A combination of the allocation table and the mapping tree can be also further used for Deleting a Volume in the storage system.

For purpose of illustration only, in the following description each logical volume is associated with a dedicated mapping tree. Those skilled in the art will readily appreciate that the teachings of the present invention are applicable in a similar manner to a mapping tree associated with a group of logical volumes (e.g. one mapping tree for entire virtual partition, for a combination of a logical volume and its respective snapshot(s), etc.). For convenience, addresses in the IVAS may be assigned separately for each volume and/or volumes group.

Referring to FIGS. 6-10, there are schematically illustrated examples of mapping trees (and associated allocation tables) representing examples of function allocating addresses related to physical storage space (e.g. DBA, VDA) to addresses related to a given logical volume (e.g. LBA, VUA), such function being referred to hereinafter as an “allocation function”.

In accordance with certain embodiments of the present invention, the mapping tree (referred to hereinafter also as “tree”) has a trie configuration, i.e. is configured as an ordered tree data structure that is used to store an associative array, wherein a position of the node in the trie indicates certain values associated with the node. There are three types of nodes in the mapping tree: a) having no associated values, b) associated with a pointer to a further node, or c) associated with numerical values, such nodes representing the leaves of the tree. In accordance with certain embodiments of the present invention, a leaf in the mapping tree indicates the following: 93 The depth of the leaf in the tree represents the length of a contiguous range of addresses related to the logical volume that is mapped by the tree: the deeper the leaf, the shorter the range it represents (and vice versa: the closer the leaf to the root, the longer the contiguous range it represents). The sequential number of a leaf node k can be calculated as k=((maximal admissible number of addresses related to the physical storage space)/(number of contiguous addresses in the range of addresses related to the logical volume))−1. 94 A given path followed from root to the leaf indicates an offset of the respective range of addresses within the given logical volume. Depending on right and/or left branches comprised in the path, the path is represented as a string of 0s and 1s, with 0 for a one-side (e.g. left) branches and 1 for another-side (e.g. right) branches. 95 The value associated with the leaf indicates an offset of respective contiguous range of addresses related to the physical storage space and corresponding to the contiguous range of addresses within the given volume.

Updating the mapping trees is provided responsive to predefined events (e.g. receiving a write request, allocation of VDA address, destaging respective data from a cache, physical writing the data to the disk, etc.).

The mapping tree can be linearized when necessary. Accordingly, the tree can be saved in a linearized form in the disks or transmitted to a remote system thus enabling its availability for recovery purposes.

For purpose of illustration only, the following description is provided in terms of a binary trie. Those skilled in the art will readily appreciate that the teachings of the present invention are applicable in a similar manner to Nary trie, where N is a number of elements in a RAID group. For example, for RAID6 application with 16 RAID group, the tree can be configured as 16-ary trie with a bottom layer comprising 14 branches corresponding to 14 data portions.

For purpose of illustration only, the following description is provided with respect to the mapping tree operable to provide Internal-to-Physical Virtual Address Mapping, i.e. between VUA and VDA addresses. Those skilled in the art will readily appreciate that, unless specifically stated otherwise, the teachings of the present invention are applicable in a similar manner to direct mapping between logical and physical locations of data portions and/or groups thereof, i.e. between LBA and DBA addresses, for mapping between LBA and VDA, between VUA and DBA, etc.

The maximal admissible number of VUAs in a logical volume is assumed as equal to 14*16.sup.15−1, while the maximal admissible VDA in the entire storage system is assumed as equal to 2.sup.42−1. Further, for simplicity, the range of VUAs in a given logical volume is assumed as 0−2.sup.48, and the range of VDAs in the entire storage system is assumed as 0−2.sup.32. Those skilled in the art will readily appreciate that these ranges are used for illustration purposes only.

Allocation function VDA_allot (VUA_address, range_length)=<(VDA_address, range_length) maps a range of contiguous VUAs to a range of contiguous VDAs.

By way of simplified non-limiting example, FIG. 6a schematically illustrates mapping of entire range of contiguous addresses (VUA) corresponding to a volume LV0 to addresses (VDA) corresponding to the physical address space. VUA range starts at offset 0 and has a length of 2.sup.32 allocation units, VDU range also starts at offset 0 and has a length of 2.sup.32 allocation units. The mapping tree (degenerated in this case) representing corresponding allocation function VDA_Alloc.sub.LV0 (0, 2.sup.32)=(0, 2.sup.32) is illustrated in FIG. 6b; the tree comprises a single node and a root, which is also a leaf with associated value equal to 0. The leaf in the illustrated tree indicates the following: 103 the depth of the leaf is a single node, and hence it represents the entire range of length (2.sup.32); 104 the specific path followed from root to leaf is empty and hence it indicates that the initial VUA-offset is 0; 105 the value associated with the leaf is 0, and hence the initial VDA-offset of the range is 0.

The mapping tree illustrated in FIG. 6b is associated with the corresponding VDA Allocation Table illustrated in FIG. 6c. In the illustrated example the entire range of VDA addresses has been allocated, and there is no room for further allocations.

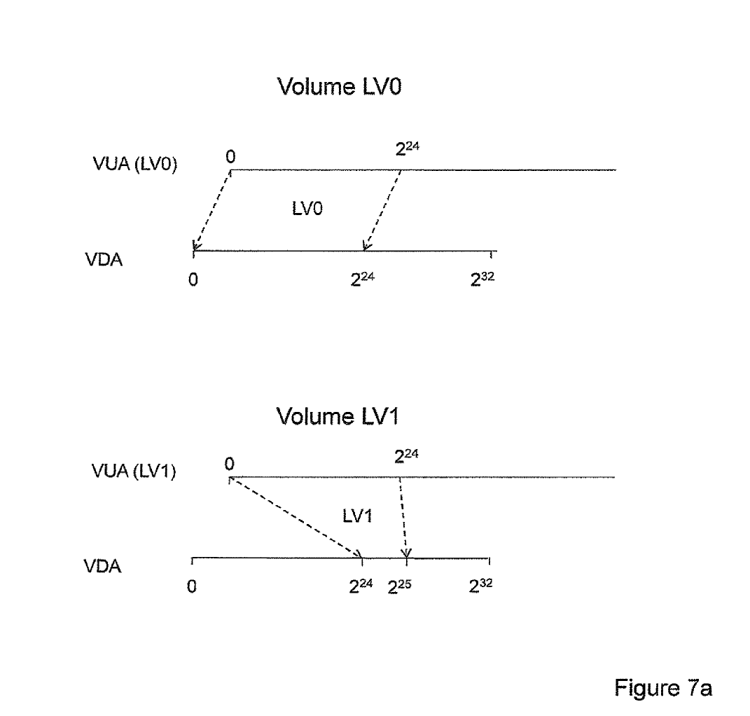

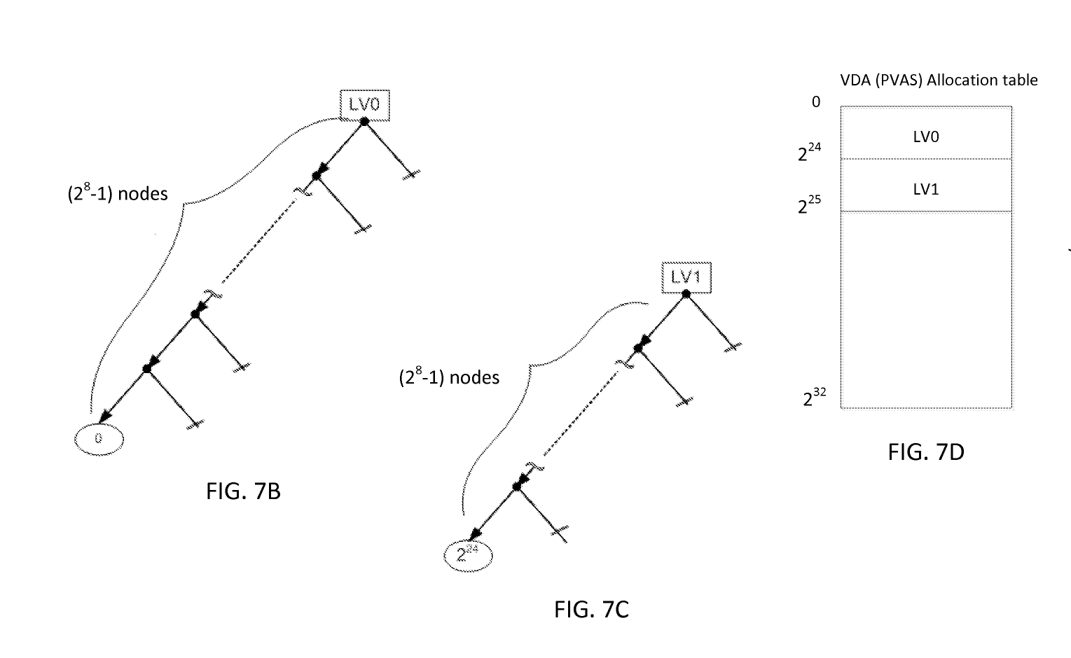

Referring now to FIG. 7a, there is schematically illustrated other non-limiting example of mapping a range of addresses corresponding to volumes LV0 and LV1, each at offset 0 in the respective volume, has size 1 TB (i.e. 2.sup.24 allocation units), and represented by a string of contiguous VUA addresses to be mapped into corresponding contiguous ranges of VDAs. It is assumed for illustration purposes that the VDA range for volume LV1 is allocated after allocation provided for volume LV1, and that PVAS was entirely free before starting the allocation process.

The allocation function for volume LV0 is VDA_Alloc.sub.LV0 (0, 2.sup.24)=(0, 2.sup.24) and is presented by the mapping tree illustrated in FIG. 7b. The allocation function for volume LV1 is VDA_Alloc.sub.Lv1 (0, 2.sup.24)=(2.sup.24, 2.sup.24) and is presented by the mapping tree illustrated in FIG. 7c. The mapping trees are associated with the VDA Allocation Table illustrated in FIG. 7d.

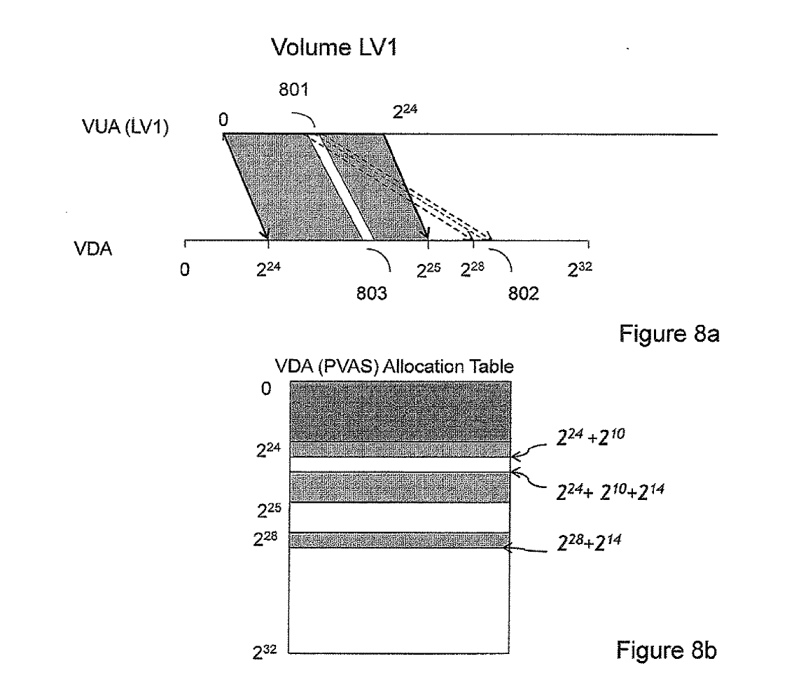

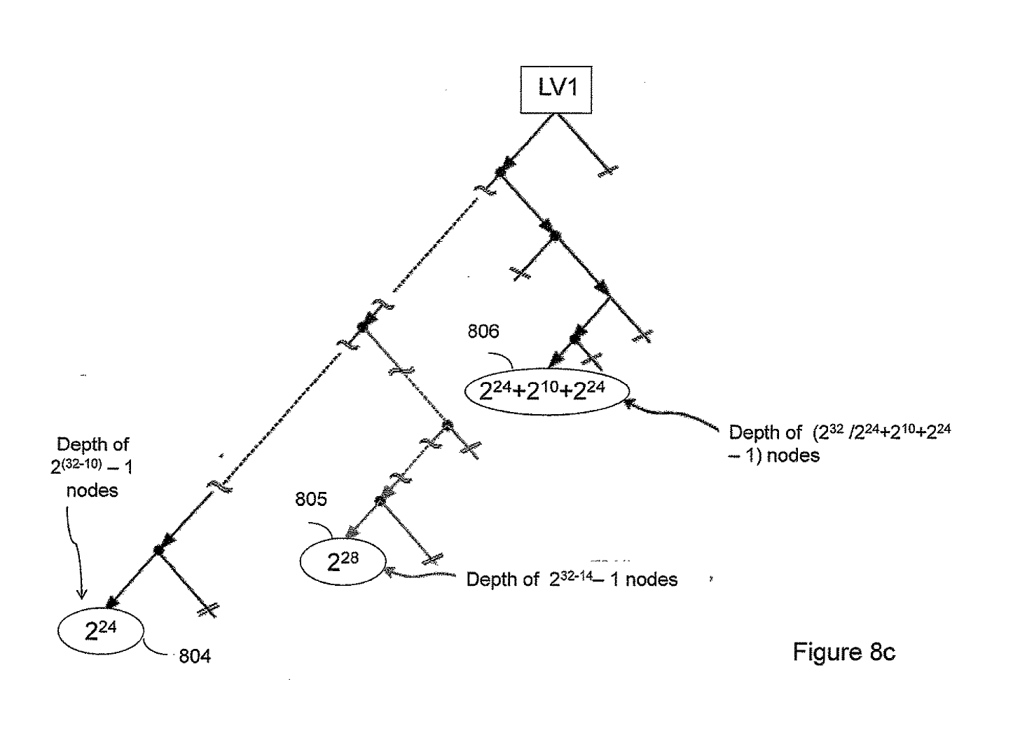

The illustrated trees indicate the following: 110 The depth of the leaves in both trees is 2.sup.8−1. Since the maximal admissible number of addresses related to the physical storage space is assumed as 2.sup.32, each leaf represents a range of contiguous VUAs equal to 2.sup.32−8=2.sup.24. 111 The paths from root to leaf in both trees are “all left branches”, and hence correspond to a string of k=2.sup.8 zeros. As will be further detailed with reference to FIG. 8c, such a string is interpreted as an indication that the represented VUA-offsets is 0.

The value associated with the leaf in the tree of LU0 is 0, and hence the initial VDA-offset is 0. The value associated with the leaf in the tree of LU1 is 2.sup.24, and hence the initial VDA-offset of the range is 2.sup.24.

Accordingly, in both illustrated trees, position of the leaves, respective path from the root to the leaves and value associated with the leaves correspond to illustrated respective allocation functions.

Referring now to FIG. 8a, there is schematically illustrated a non-limiting example of mapping a range of previously allocated addresses responsive to modification by a write request. A VUA range 801 of length 1 GB (i.e., 2.sup.30 bytes or 2.sup.14 allocation units) is located at offset 2.sup.10 within LV1 detailed with reference to FIGS. 7a-7d. Upon modification, the range 801 has been provided with the corresponding range 802 of allocated VDA addresses, starting at VDA-offset 2.sup.28, and previously allocated to this VUAs range of VDA addresses 803 has become non-allocated (and may be further freed by defragmentation/garbage collection processes).

Upon modification, previously contiguous range of VUAs is constituted by 3 sub-ranges: 1) contiguous range with VUA-offset 0 and length 2.sup.10, 2) modified contiguous range with VUA-offset 2.sup.10 and length 2.sup.14, and 3) contiguous range with VUA-offset 0+2.sup.10+2.sup.10 and 2.sup.24−2.sup.10−2.sup.14.

The allocation function for 1.sup.st sub-range is VDA_Alloc.sub.LV1 (0, 2.sup.10)=(2.sup.24, 2.sup.10).

The allocation function for the 2.sup.nd (modified) sub-range is VDA_Alloc.sub.LV1 (0+2.sup.10, 2.sup.14)=(2.sup.28, 2.sup.14).

The allocation function for the 3.sup.rd sub-range is VDA_Alloc.sub.LV1 (0+2.sup.10+2.sup.14,2.sup.24−2.sup.10−2.sup.14)=(2.sup.24+2.sup.10+2.sup−0.14,2.sup.24−2.sup.10−2.sup.14).

The respective allocation table is illustrated in FIG. 8b, and respective mapping tree is illustrated in FIG. 8c.

Each contiguous range of VUA addresses is represented by a leaf in the tree. The leaves in the illustrated tree indicate the following: 121 The leaf 804 corresponds to the 1.sup.st sub-range, the leaf 805 corresponds to the 2.sup.nd (modified) sub-range, and the leaf 806 corresponds to the 3.sup.rd sub-range. The respective depths of the leaves correspond to respective sizes of VUA sub-range. Namely, the node number of leaf 804 ksub.1=(2.sup.32−10−1), the node number of leaf 805 k.sub.2=(2.sup.32−14−1), and the node number of leaf 806 k.sub.3=((2.sup.32/(2.sup.24+2.sup.10+2.sup.14))−1. 122 The value associated with the leaf 804 is .sup.224, and hence the VDA-offset is .sup.224. The value associated with the leaf 805 is .sup.228, and hence the VDA-offset of the sub-range is .sup.228. The value associated with the leaf 806 is 2.sup.24+2.sup.10+2.sup.14 which corresponds to the VDA-offset of the sub-range. 123 Characteristics of a path in the tree can be translated into VUA-offset with the help of the following expression:

$${\sum }_{i = 0}^{l - 1} {r}_{i} \cdot {2}^{( M - i - 1 )}$$

where M is the power of two in the maximal number of admissible VUA addresses in the logical unit (in the illustrated examples M=48), d is the depth of the leaf, i=0, 1, 2, 3, d−1 are the successive nodes in the tree leading to the leaf, and r.sub.i=0 for a left-hand branching, and r.sub.i=for a right-hand branching.

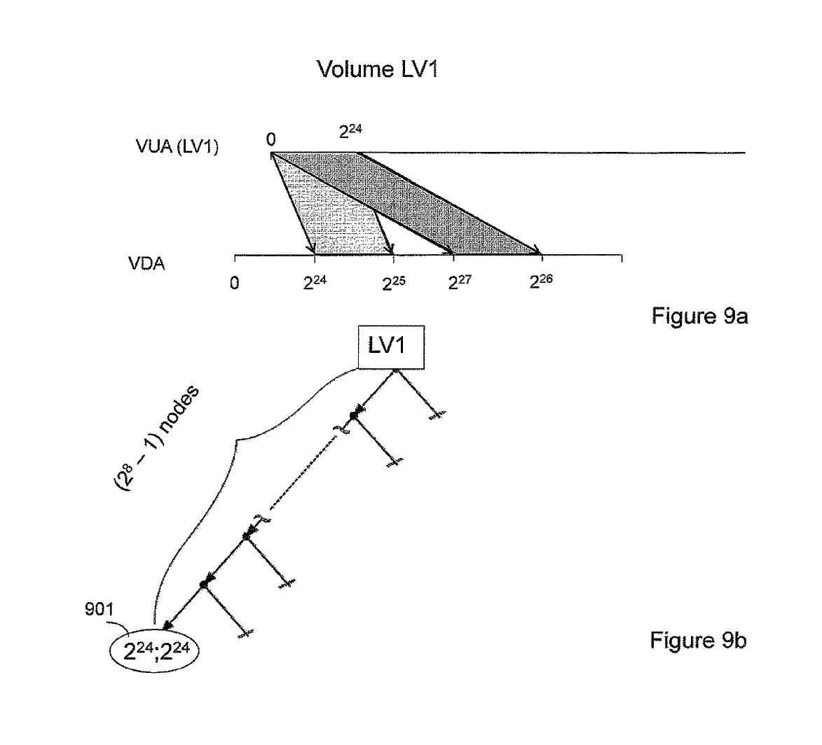

Referring now to FIG. 9a, there is schematically illustrated a non-limiting example of mapping a range of contiguous VUA addresses to more than one corresponding ranges of VDA addresses. As illustrated, contiguous range (0,2.sup.24) of LV1, is mapped to two different VDA ranges, namely (2.sup.24,2.sup.24) and (2.sup.26,2.sup.24) as described by corresponding allocation function with multiple allocations (referred to hereinafter as “multiple allocation function”): Multi-VDA-Alloc.sub.LV1(0,2.sup.24)=[(2.sup.24,2.sup.24); (2.sup.26,2.sup.24).

The corresponding mapping tree is illustrated in FIG. 9b. Leaf 901 comprises multiple references, pointing on to different VDA-offsets corresponding to two respective VDA ranges.

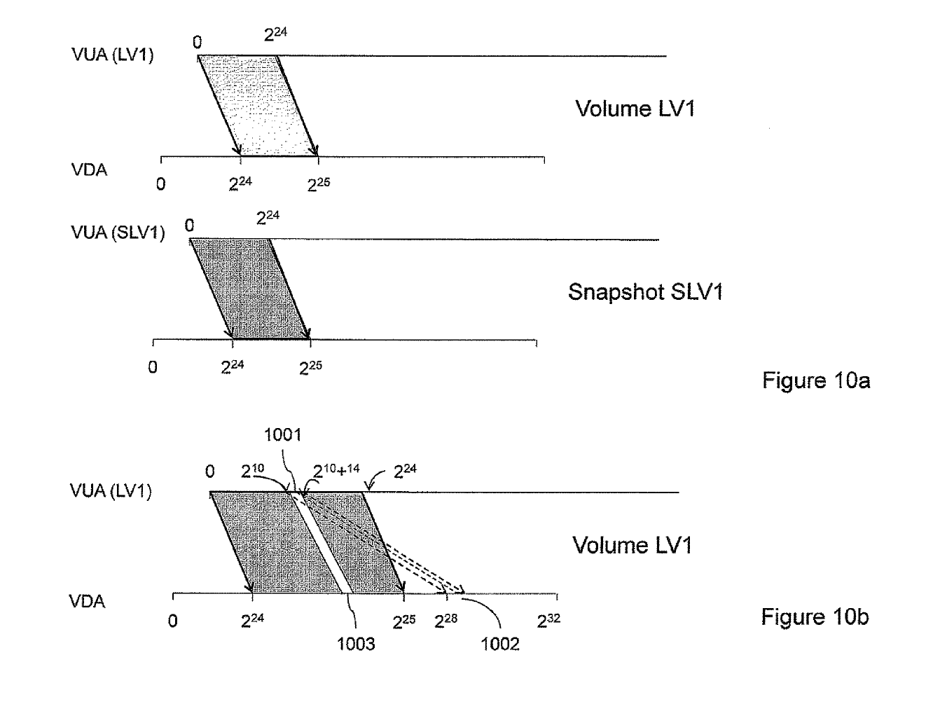

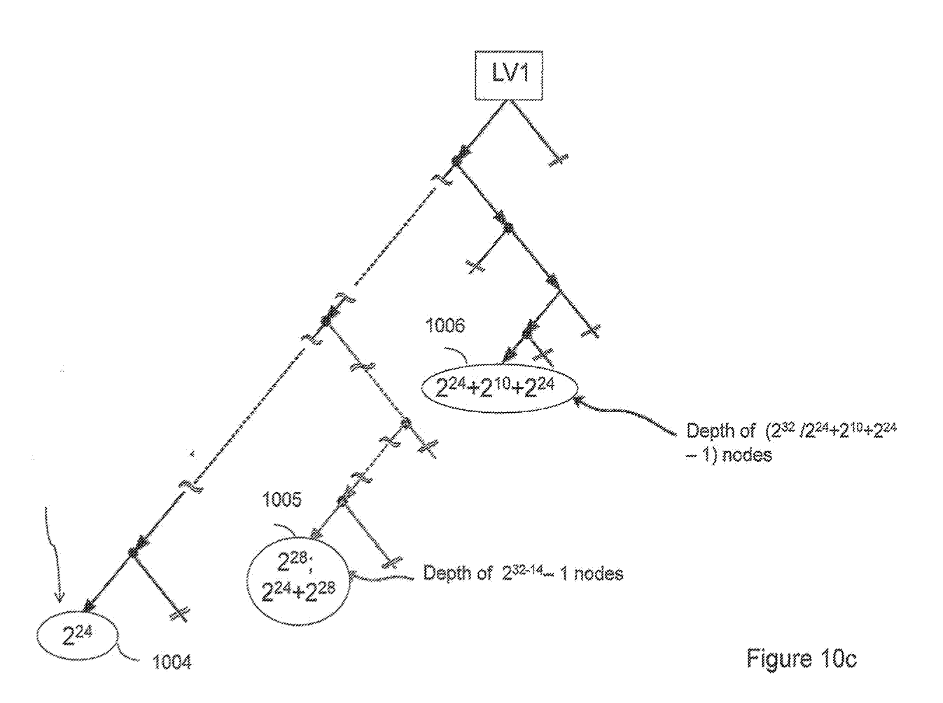

In accordance with certain embodiments of the present invention, multiple-reference leaves can be used for effectively mapping between the logical volumes and generated snapshots. FIG. 10a schematically illustrates a non-limiting example of mapping a range of contiguous VUA addresses in the volume LV1 and a range of contiguous VUA addresses in the corresponding snapshot volume SLV1 to the same range of VDA addresses. The respective allocation function for the volume LV1 is VDA-Alloc.sub.LV1(0,2.sup.24) (2.sup.24; 2.sup.24); and the allocation function for the volume SLV1 is VDA-Alloc.sub.SLV1(0,2.sup.24)=(2.sup.24,2.sup.24).

FIG. 10b schematically illustrates a non-limiting example of mapping a range of the source volume LV1 and respective snapshot volume SLV1 upon modification by a write request at VUA-offset 2.sup.10 and having a length of 2.sup.14 allocation units. Likewise, as was detailed with reference to FIG. 8a, new data 1001 associated with the source volume LV1 are allocated to a new physical location 1002 (e.g., the range starting at VDA-offset 2.sup.26 and having a length of 2.sup.14 sections).

However, the snapshot SLV1 will continue pointing to the non-updated data in its location 1003. At the same time, both LV1 and SLV1 will continue to point simultaneously to the same data in the ranges outside the modified range. In terms of the allocation functions, the situation may be described as follows:

The allocation function for 1.sup.st sub-range in LV1 is VDA-Alloc.sub.LV1 (0,2.sup.10)=(2.sup.24, 2.sup.10);

The allocation function for 2.sup.st sub-range in LV1 is VDA-Alloc.sub.LV1 (0+2.sup.10,2.sup.14)=(2.sup.28,2.sup.14),

The allocation function for 3.sub.rd sub-range in LV1 is VDA-Alloc.sub.LV1(0+2.sup.10+2.sup.14,2.sup.24−2.sup.10−2.sup.14)=2.sup.2−4+2.sup.10+2.sup.14,2.sup.24−2.sup.10−2.sup.14);

The allocation function for SLV1 is VDA-Alloc.sub.sLV1 (0,2.sup.24)(2.sup.24,2.sup.24).

The respective tree illustrated in FIG. 10c represents the mapping of the logical volume LV1, and at the same time mapping of respective snapshot SLV1. Likewise, the same tree may represent mapping of all snapshots generated for a given volume. Moreover, the tree represents the allocation of the data associated with the source and with the snapshot(s) after data is modified by a write request.

Each contiguous range of VUA addresses is represented by a leaf in the tree. The leaves in the illustrated tree indicate the following: 135 The leaf 1004 corresponds to the 1.sup.st sub-range, the leaf 1005 corresponds to the 2.sup.nd (modified) sub-range, and the leaf 1006 corresponds to the 3.sup.rd sub-range. The respective depths of the leaves correspond to respective sizes of VUA sub-range. Namely, the node number of leaf 1004 k.sub.1=(2.sup.32−10−1), the node number of leaf 1005 k.sub.2=(2.sup.32−14−1), and the node number of leaf 1006 k3=((2.sup.32/(2.sup.24+2.sup.10+2.sup.14))−1. 136 Likewise, as was detailed with reference to FIG. 8c, for each leaf characteristics of respective path from the root to the leaf indicate VUA-offset of the respective VUA sub-range.

The value associated with the leaf 1004 is 2.sup.24, and hence the 1.sup.st sub-range is mapped to VDA-offset 2.sup.24. The value associated with the leaf 1005 has multiple reference. Hence the 2.sup.nd sub-range is mapped to two locations: modified data in LV1 are mapped to VDA-offset 2.sup.28, while the old, non-modified data in the snapshot SLV1 are mapped to the old VDA-offset 2.sup.24+2.sup.10. The value associated with the leaf 1006 is 2.sup.24+2.sup.10+2.sup.14 which corresponds to the VDA-offset of the sub-range. The teachings of the present application of providing the mapping between addresses related to logical volumes and addresses related to physical storage space with the help of a mapping tree(s) configured in accordance with certain embodiments of the present invention and detailed with reference to FIGS. 6-10 are applicable for Internal-to-Physical virtual address mapping (i.e. between VUA and VDA), for direct mapping between logical and physical locations of data portions and/or groups thereof (i.e. between LBA and DBA addresses), for mapping between logical address space and virtual layer representing the physical storage space (i.e. between LBA and VDA), for mapping between virtual layer representing the logical address space and the physical address space (i.e. between VUA and DBA), etc.

Implementing the disclosed mapping trees in combination with Internal-to-Physical virtual address mapping between the virtual layers enables more efficient and smooth interaction between a very large amount of Logical Objects and a much smaller amount of actual physical storage data blocks. Among further advantages of such a combination is effective support of a snapshot and/or thin volume management mechanisms implemented in the storage system, as well as defragmentation and garbage collection processes.

Among advantages of certain embodiments comprising mapping to a virtualized physical space is a capability of effective handling continuous changes of real physical addresses (e.g. because of a failure or replacement of a disk, recalculation of the RAID parities, recovery processes, etc.). In accordance with such embodiments, changes in the real physical address require changes in mapping between PVAS and the physical storage space; however, no changes are required in the tree which maps the addresses related to logical volumes into virtual physical addresses VDA.

Among advantages of certain embodiments comprising mapping virtualized logical addresses (VUA) is a capability of effective handling of snapshots. As IVAS provides virtualization for logical volumes and snapshots, the tree may be used for simultaneous mapping of both a given logical volume and respective snapshot(s) at least until modification of the source. Likewise, in the case of thin volume, IVAS is used for immediate virtual allocation of logical volumes, and tree mapping avoids a need in an additional mechanism of gradually exporting respective addresses with the growth of the thin volume.

According to an embodiment of the invention a pre-fetch and additionally or alternatively a de-fragmentation operation can be affected by one or more characteristics of a mapping tree that is used to map between contiguous address ranges supported by one or more virtualization layers.

The term certain data portion refers to a data portion that is to be fetched while an additional data portion refers to a data portion that should be pre-fetched. The following example refers to a trie but it is applicable to other mapping trees.

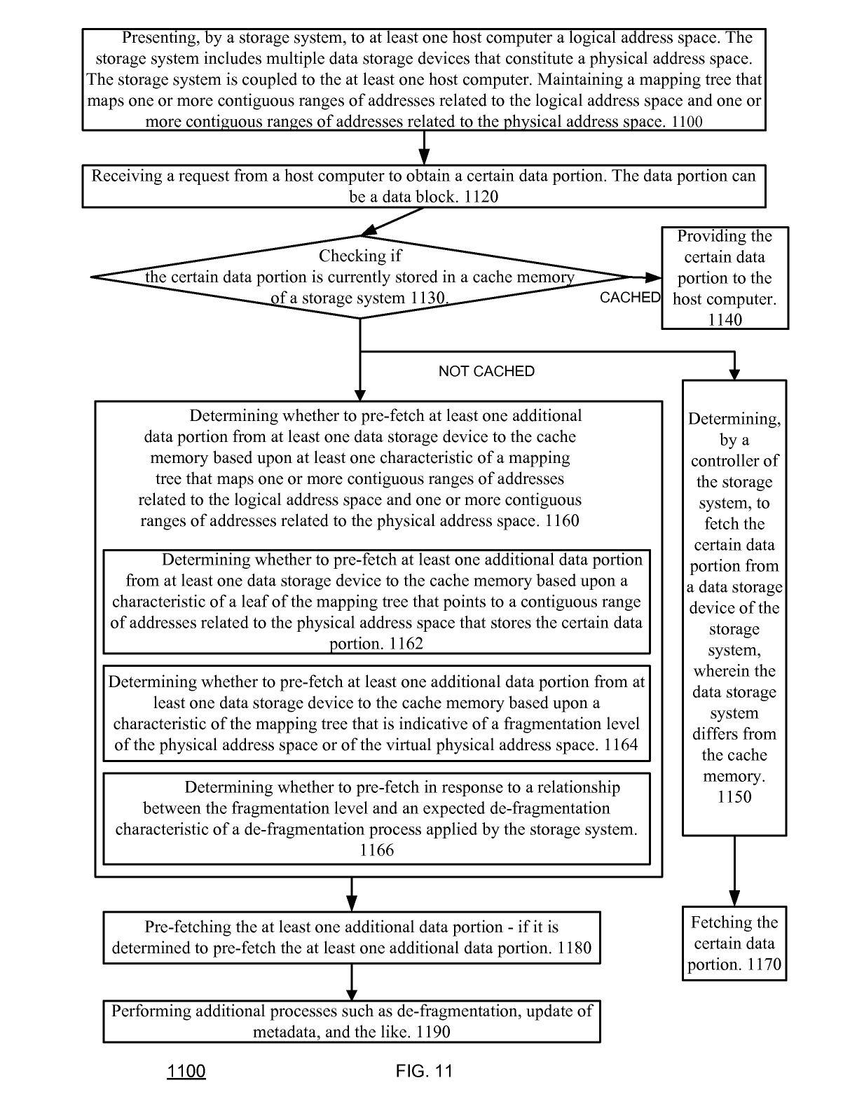

FIG. 11 illustrates a method 1100 for pre-fetching according to an embodiment of the invention.

Method 1100 includes stage 1110 of presenting, by a storage system, to at least one host computer a logical address space. The storage system includes multiple data storage devices that constitute a physical address space. The storage system is coupled to the at least one host computer.

Stage 1110 may also include maintaining a mapping tree that maps one or more contiguous ranges of addresses related to the logical address space and one or more contiguous ranges of addresses related to the physical address space. Referring to the example set forth in FIGS. 2, 4, 6A, 7C, 8C, 9B and 10C, the mapping tree can map between contiguous ranges of addresses of the internal virtual address space (IVAS) and between contiguous ranges of addresses of the Physical Virtual Address Space (PVAS).

The mapping tree can be provided per logical address space, per logical volume, per statistical segment or per other part of the logical address space.

Method 1100 also includes stage 1120 of receiving a request from a host computer to obtain a certain data portion. The data portion can be a data block or a sequence of data blocks.

Stage 1120 may be followed by stage 1130 of checking if the certain data portion is currently stored in a cache memory of a storage system. The checking can be executed by a cache controller or any other controller of the storage system.

If it is determined that the certain data portion is stored in the cache memory then stage 1130 is followed by stage 1140 of providing the certain data portion to the host computer.

If it is determined that the certain data portion is not stored in the cache memory then stage 1130 is followed by stages 1150 and 1160.

Stage 1150 may include determining, by a fetch module of the storage system, to fetch the certain data portion from a data storage device to a cache memory of the storage system.

Stage 1150 may be followed by stage 1170 of fetching (by the fetch module) the certain data portion.

Stage 1160 may include determining whether to pre-fetch (by a pre-fetch module of the storage system) at least one additional data portion from at least one data storage device to the cache memory based upon at least one characteristic of a mapping tree that maps one or more contiguous ranges of addresses related to the logical address space and one or more contiguous ranges of addresses related to the physical address space.

According to various embodiments of the invention the characteristic of the mapping tree can be a number of leafs in the mapping tree, a length of at least one path of the mapping tree, a variance of lengths of paths of the mapping tree, an average of lengths of paths of the mapping tree, a maximal difference between lengths of paths of the mapping tree, a number of branches in the mapping tree, a relationship between left branches and right branches of the mapping tree. For example each one of a small number of leafs, short length paths, small differences between lengths of paths, small number of branches, can be indicative of a passive contiguous range of addresses.

According to other embodiments of the invention the characteristic of the mapping tree is a characteristic of a leaf of the mapping tree that points to a contiguous range of addresses related to the physical address space that stores the certain data portion. This contiguous range of addresses can belong, for example, to the Physical Virtual Address Space or to the physical address space.

The characteristic of the leaf of the mapping tree can be a size of the contiguous range of addresses related to the physical address space that stores the certain data portion. In a nut shell, the deeper the leaf, the shorter the continuous range of addresses it represents. The closer the leaf to the root of the mapping tree, the longer the continuous range of addresses it represents.

Accordingly, stage 1160 can include stage 1162 of determining whether to pre-fetch at least one additional data portion from at least one data storage device to the cache memory based upon a characteristic of a leaf of the mapping tree that points to a contiguous range of addresses related to the physical address space that stores the certain data portion.

Stage 1160 may be followed by stage 1180 of pre-fetching the at least one additional data portions if it is determined to pre-fetch the at least one additional data portions.

The fetching and the pre-fetching can result in retrieving the certain data portion and additional data portions from the same contiguous range of addresses that is represented by a single leaf of the mapping tree.

The fetching and the pre-fetching can result in retrieving the certain data portion and additional data portions from different contiguous ranges of addresses that are represented by different leafs of the mapping tree.

According to an embodiment of the invention the characteristic of the mapping tree is indicative of a fragmentation level of the physical address space or of the virtual physical address space.

Accordingly, stage 1160 may include stage 1164 of determining whether to pre-fetch at least one additional data portion from at least one data storage device to the cache memory based upon a characteristic of the mapping tree that is indicative of a fragmentation level of the physical address space or of the virtual physical address space.

Stage 1164 may include determining to pre-fetch at least one additional data portion if the fragmentation level is above a fragmentation level threshold or determining to pre-fetch at least one additional data portion if the fragmentation level is below a fragmentation level threshold. The same can be applicable to ranges of fragmentation levels.

According to an embodiment of the invention the determination of whether to pre-fetch may also be responsive to a relationship between the fragmentation level and an expected de-fragmentation characteristic of a de-fragmentation process applied by the storage system. This is illustrates by stage 1166 of determining whether (and how) to pre-fetch in response to a relationship between the fragmentation level and an expected de-fragmentation characteristic of a de-fragmentation process applied by the storage system.

The expected de-fragmentation characteristic of the de-fragmentation process is an expected frequency of the de-fragmentation process.

Thus, if the de-fragmentation process is expected to be executed in a very frequent manner—the de-fragmentation levels are expected to be less significant (are confined to a more limited range) than in the case of sparser de-fragmentation processes.

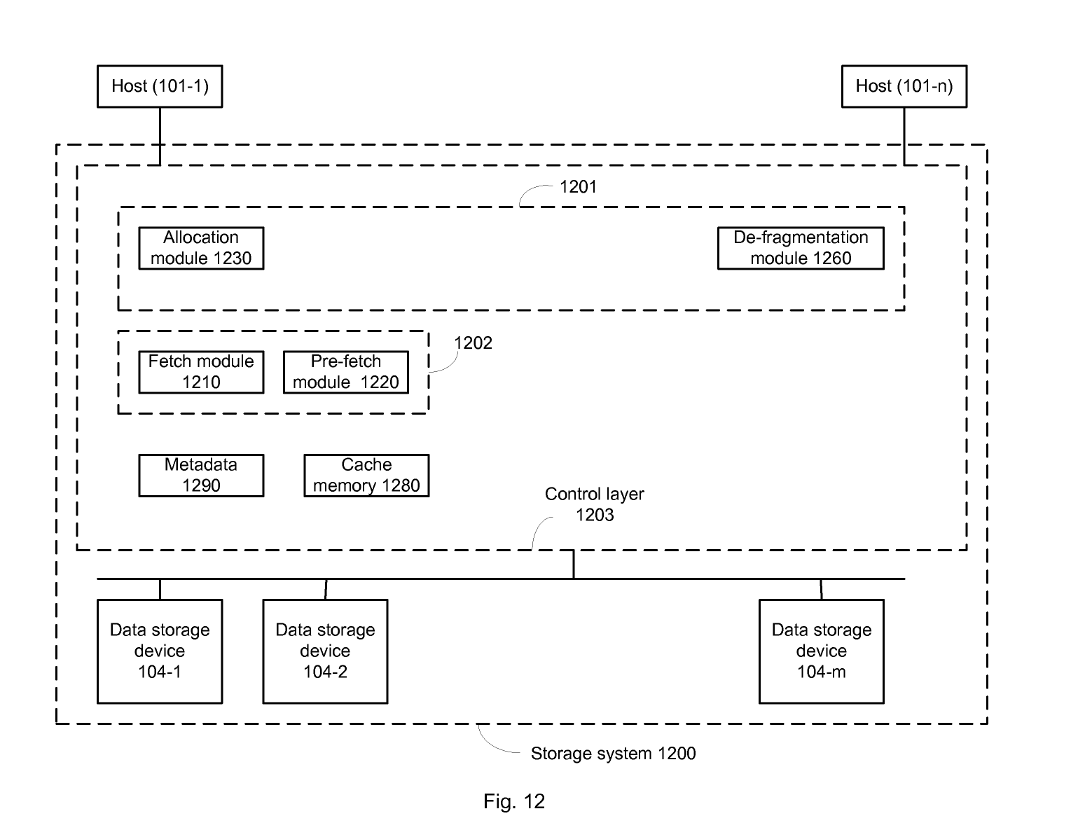

FIG. 12 illustrates a storage system 1200 and its environment according to an embodiment of the invention.

Storage system 1200 is coupled to host computers 101-1 till 101-n. Storage system 1200 includes a control layer 1203 and multiple data storage devices 104-1 till 104-m. These data storage devices differ from a cache memory 1280 of the control layer 1203.

The control layer 1203 can support multiple virtualization layers, such as but not limited the two virtualization layers (first virtual layer (VUS) and second virtual layer (VDS)) of FIGS. 6 and 7.

The data storage devices (104-1 till 104-m) can be disks, flash devices, Solid State Disks (SSD) or other storage means.

a. The control layer 1203 is illustrated as including multiple modules (1210, 1220, 1230 and 1260). It is noted that one or more of the modules includes one or more hardware components. It is noted that one or more of the modules includes one or more hardware components. For example, a pre-fetch module 1020 can include hardware components.

The storage system 1200 can execute any method mentioned in this specification and can execute any combination of any stages of any methods disclosed in this specification.

The control layer 1203 may include a controller 1201 and a cache controller 1202. The cache controller 1202 includes a fetch module 1210 and a pre-fetch module 1220. It is noted that the controller 1201 and cache controller 1202 can be united and that the modules can be arranged in other manners.

The pre-fetch module 1220 can include (a) a pre-fetch evaluation and decision unit that determines whether to pre-fetch data portions and how to pre-fetch data portions, and (b) a pre-fetch unit that executes the pre-fetch operation. The fetch module 1210 can include a fetch evaluation and decision unit and a fetch unit. For simplicity of explanation these units are not shown.

The allocation module 1230 can be arranged to provide a translation between virtualization layers such as between the first virtual layer (VUS) and the second virtual layer (VDS). The allocation module 1230 can maintain one or more mapping trees—per the entire logical address space, per a logical volume, per a statistical segment and the like.

The de-fragmentation module 1260 may be arranged to perform de-fragmentation operations.

Metadata 1290 represents metadata that is stores at the control layer 1203. Such metadata 1290 can include, for example, logical volume pre-fetch policy rules, and the like.

The pre-fetch module 1220 can determine when to perform a pre-fetch operation and may control such pre-fetch operation. It may base its decision on at least one characteristic of a mapping tree that maps one or more contiguous ranges of addresses related to the logical address space to one or more contiguous ranges of addresses related to the physical address space.

According to an embodiment of the invention additional metadata can be provided in order to assist in searching for contiguous ranges of addresses that are characterized by certain I/O activity levels such as lowest I/O activity level (cold contiguous ranges of addresses), highest I/O activity level (hot contiguous ranges of addresses) or any other I/O activity levels (if such exist).

The following description is applicable for hierarchical mapping structures, such as hierarchical structure (tree) 100, e.g. a B-tree, a Trie or any other kind of a mapping tree that is used for storing address mapping.

According to an embodiment of the invention a mapping tree further includes timing information. Thus, a mapping tree can include timestamps in addition to fields of address references in each node.

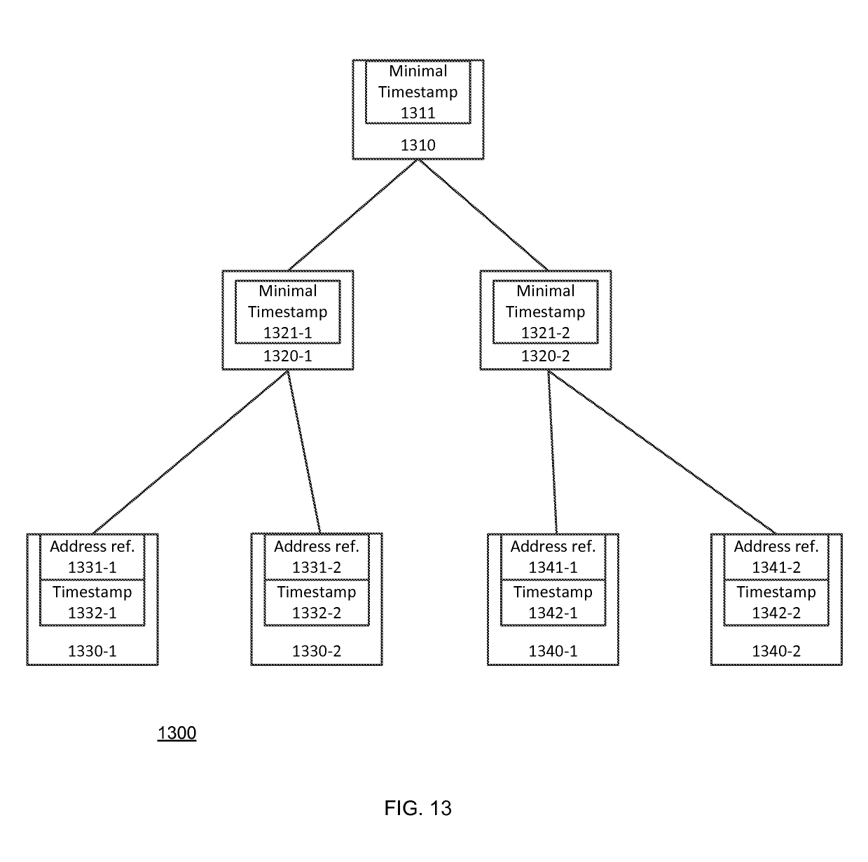

FIG. 13 illustrates a mapping tree 1300 according to an embodiment of the invention.

Referring to the example set forth in FIG. 13, each node, 1330-1, 1330-2, 1340-1 and 1340-2, in the lowest level of mapping tree 1300 stores a timestamp, for example: timestamps 1332-1, 1332-2, 1342-1 and 1342-2, of the last update related to the memory area indicated in the node by address reference 1330-1, 1330-2, 1340-1 and 1340-2. Each node in the upper levels of the mapping tree 1300 includes minimal timestamps of its descendent nodes. For example, node 1320-1 includes a minimal timestamp 1321-1, which is a minimum between timestamps 1332-1 and 1332-2 and node 1320-2 includes a minimal timestamp 1321-2, which is a minimum between timestamps 1342-1 and 1342-2. The same mechanism applies to the root node 1310 that stores a minimal timestamp 1310-1, which is the minimum between timestamps 1321-1 and 1321-2.

When searching for contiguous ranges of addresses (also referred to memory areas) that are colder than a certain value (time indication), minimal timestamp 1310-1 in root node 1310 is read. If it is lower than or equal to the certain value, the lower level nodes 1320-1 and 1320-2 are checked and the tree traversing continues in the route of the node(s) that includes a minimal timestamp that is equal to minimal timestamp 1310-1 or lower than the certain value, until reaching the lowest level node(s) that includes a timestamp that is equal to timestamp 1310-1 or lower than the certain value. The address reference indicated in the leaf node(s) is an address range that is colder than or as cold as the certain value.

For searching the colder area, the mapping tree 1300 is traversed by using the path with the minimal timestamp at each node.

The mapping tree 1300 can be used for de-fragmentation purposes (for example—de-fragmenting contiguous ranges of addresses that are represented by different leafs that are associated with the same timestamps) or for pre-fetching operations.

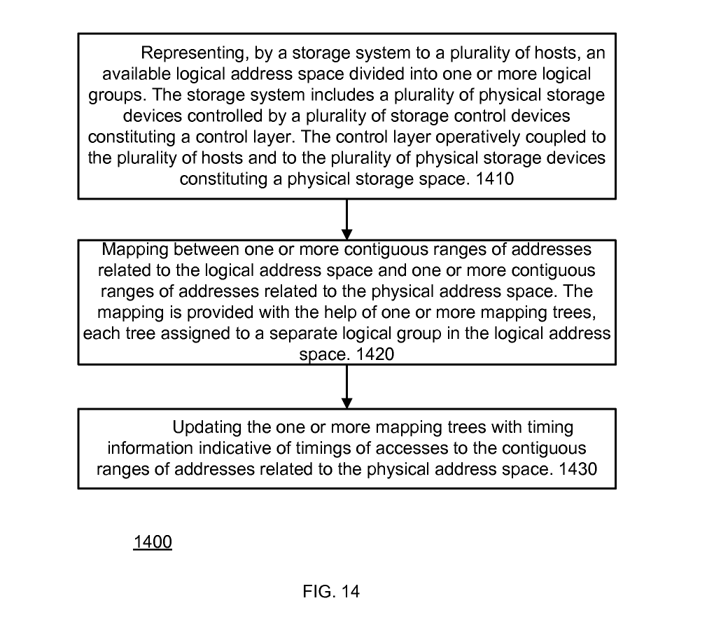

FIG. 14 illustrates method 1400 according to an embodiment of the invention.

Method 1400 may include stages 1410, 1420 and 1430.

Stage 1410 may include representing, by a storage system to a plurality of hosts, an available logical address space divided into one or more logical groups. The storage system includes a plurality of physical storage devices controlled by a plurality of storage control devices constituting a control layer. The control layer operatively coupled to the plurality of hosts and to the plurality of physical storage devices constituting a physical storage space.

Stage 1420 may include mapping between one or more contiguous ranges of addresses related to the logical address space and one or more contiguous ranges of addresses related to the physical address space. The mapping is provided with the help of one or more mapping trees, each tree assigned to a separate logical group in the logical address space.

Stage 1430 may include updating the one or more mapping trees with timing information indicative of timings of accesses to the contiguous ranges of addresses related to the physical address space.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present invention.

It will also be understood that the system according to the invention may be a suitably programmed computer. Likewise, the invention contemplates a computer program being readable by a computer for executing the method of the invention.

The invention further contemplates a machine-readable memory tangibly embodying a program of instructions executable by the machine for executing the method of the invention.

Those skilled in the art will readily appreciate that various modifications and changes can be applied to the embodiments of the invention as hereinbefore described without departing from its scope, defined in and by the claims associated with the present invention.

1. A method for pre-fetching, comprising:
presenting, by a storage system and to at least one host computer, a logical address space; wherein the storage system comprises multiple data storage devices that constitute a physical address space; wherein the storage system is coupled to the at least one host computer;
determining, by a fetch module of the storage system, to fetch a certain data portion from a data storage device to a cache memory of the storage system;
determining, by a pre-fetch module of the storage system, whether to pre-fetch at least one additional data portion from at least one data storage device to the cache memory based upon at least one characteristic of a mapping tree that maps one or more contiguous ranges of addresses related to the logical address space and one or more contiguous ranges of addresses related to the physical address space; and
pre-fetching the at least one additional data portions if it is determined to pre-fetch the at least one additional data portions.

2. The method according to claim 1, wherein the characteristic is a number of leafs in the mapping tree.

3. The method according to claim 1, wherein the characteristic is a length of at least one path of the mapping tree.

4. The method according to claim 1, wherein the characteristic is a variance of lengths of paths of the mapping tree.

5. The method according to claim 1, wherein the characteristic is an average of lengths of paths of the mapping tree.

6. The method according to claim 1, wherein the characteristic is a maximal difference between lengths of paths of the mapping tree.

7. The method according to claim 1, wherein the characteristic is a number of branches in the mapping tree.

8. The method according to claim 1, wherein the characteristic is a relationship between left branches and right branches of the mapping tree.

9. The method according to claim 1, wherein the characteristic of the mapping tree is a characteristic of a leaf of the mapping tree that points to a contiguous range of addresses related to the physical address space that stores the certain data portion.

10. The method according to claim 9 wherein the characteristic of the leaf of the mapping tree is a size of the contiguous range of addresses related to the physical address space that stores the certain data portion.

11. The method according to claim 1, wherein the certain data portion and each one of the at least one additional data portions are addressed within a contiguous range of addresses related to the physical address space that is represented by a single leaf of the mapping tree.

12. The method according to claim 1, wherein the certain data portion and at least one additional data portions are stored within different contiguous ranges of addresses related to the physical address space that are represented by different leaf of the mapping tree.

13. The method according to claim 1, wherein the characteristic of the mapping tree is indicative of a fragmentation level of the physical address space.

14. The method according to claim 13, comprising determining to pre-fetch at least one additional data portion if the fragmentation level is above a fragmentation level threshold.

15. The method according to claim 13, comprising determining to pre-fetch at least one additional data portion if the fragmentation level is below a fragmentation level threshold.

16. The method according to claim 13, wherein the determining is further responsive to a relationship between the fragmentation level and an expected de-fragmentation characteristic of a de-fragmentation process applied by the storage system.

17. The method according to claim 16, wherein the expected de-fragmentation characteristic of the de-fragmentation process is an expected frequency of the de-fragmentation process.

18. A storage system, comprising:
a cache memory;
at least one data storage device that differs from the cache memory and constitutes a physical address space;
an allocation module that is arranged to present to at least one host computer a logical address space, and to maintain a mapping tree that maps one or more contiguous ranges of addresses related to the logical address space and one or more contiguous ranges of addresses related to the physical address space;
a fetch module arranged to determine to fetch a certain data portion from a data storage device to the cache memory;
a pre-fetch module arranged to determine whether to pre-fetch at least one additional data portion from at least one data storage device to the cache memory based upon at least one characteristic of the mapping tree, and to pre-fetch the at least one additional data portions if it is determined to pre-fetch the at least one additional data portions.

19. The storage system according to claim 18, wherein the characteristic is a number of leafs in the mapping tree.

20. The storage system according to claim 18, wherein the characteristic is a length of at least one path of the mapping tree.

21. The storage system according to claim 18, wherein the characteristic is a variance of lengths of paths of the mapping tree.

22. The storage system according to claim 18, wherein the characteristic is an average of lengths of paths of the mapping tree.

23. The storage system according to claim 18, wherein the characteristic is a maximal difference between lengths of paths of the mapping tree.

24. The storage system according to claim 18, wherein the characteristic is a number of branches in the mapping tree.

25. The storage system according to claim 18, wherein the characteristic is a relationship between left branches and right branches of the mapping tree.

26. The storage system according to claim 18, wherein the characteristic of the mapping tree is a characteristic of a leaf of the mapping tree that points to a contiguous range of addresses related to the physical address space that stores the certain data portion.

27. The storage system according to claim 26, wherein the characteristic of the leaf of the mapping tree is a size of the contiguous range of addresses related to the physical address space that stores the certain data portion.

28. The storage system according to claim 26, wherein the certain data portion and each one of the at least one additional data portions are addressed within a contiguous range of addresses related to the physical address space that is represented by a single leaf of the mapping tree.

29. The storage system according to claim 26, wherein the certain data portion and at least one additional data portions are stored within different contiguous ranges of addresses related to the physical address space that are represented by different leaf of the mapping tree.

30. The storage system according to claim 26, wherein the characteristic of the mapping tree is indicative of a fragmentation level of the physical address space.

31. The storage system according to claim 30, wherein the pre-fetch module is arranged to determine to pre-fetch at least one additional data portion if the fragmentation level is above a fragmentation level threshold.

32. The storage system according to claim 30, wherein the pre-fetch module is arranged to determine to pre-fetch at least one additional data portion if the fragmentation level is below a fragmentation level threshold.

33. The storage system according to claim 30, wherein the pre-fetch module is arranged to determine in response to a relationship between the fragmentation level and an expected de-fragmentation characteristic of a de-fragmentation process applied by the storage system.

34. The storage system according to claim 33, wherein the expected de-fragmentation characteristic of the de-fragmentation process is an expected frequency of the de-fragmentation process.

35. A non-transitory computer readable medium that stores instructions for:
presenting to at least one host computer, a logical address space; wherein the storage system comprises multiple data storage devices that constitute a physical address space; wherein the storage system is coupled to the at least one host computer;
determining to fetch a certain data portion from a data storage device to a cache memory of the storage system;
determining whether to pre-fetch at least one additional data portion from at least one data storage device to the cache memory based upon at least one characteristic of a mapping tree that maps one or more contiguous ranges of addresses related to the logical address space and one or more contiguous ranges of addresses related to the physical address space; and
pre-fetching the at least one additional data portions if it is determined to pre-fetch the at least one additional data portions.

36. A storage system comprising:
a plurality of storage control devices constituting a control layer;
a plurality of physical storage devices constituting a physical storage space;
the plurality of physical storage devices are arranged to be controlled by the plurality of storage control devices;
wherein the control layer is coupled to a plurality of hosts;
wherein the control layer is operable to handle a logical address space divided into one or more logical groups and available to said plurality of hosts;
wherein the control layer further comprises an allocation module configured to provide mapping between one or more contiguous ranges of addresses related to the logical address space and one or more contiguous ranges of addresses related to the physical address space, said mapping provided with the help of one or more mapping trees, each tree assigned to a separate logical group in the logical address space; wherein the one or more mapping trees further comprising timing information indicative of timings of accesses to the contiguous ranges of addresses related to the physical address space.

37. A method, comprising:
representing, by a storage system to a plurality of hosts, an available logical address space divided into one or more logical groups; the storage system comprises a plurality of physical storage devices controlled by a plurality of storage control devices constituting a control layer; the control layer is coupled to the plurality of hosts and to the plurality of physical storage devices constituting a physical storage space;
mapping between one or more contiguous ranges of addresses related to the logical address space and one or more contiguous ranges of addresses related to the physical address space, the mapping is provided with the help of one or more mapping trees, each tree assigned to a separate logical group in the logical address space; and
updating the one or more mapping trees with timing information indicative of timings of accesses to the contiguous ranges of addresses related to the physical address space.

38. A non-transitory computer readable medium that stores instructions for:
representing to a plurality of hosts an available logical address space divided into one or more logical groups; the plurality of hosts are coupled to a storage system that comprises a plurality of physical storage devices controlled by a plurality of storage control devices constituting a control layer;
mapping between one or more contiguous ranges of addresses related to the logical address space and one or more contiguous ranges of addresses related to the physical address space, the mapping is provided with the help of one or more mapping trees, each tree assigned to a separate logical group in the logical address space; and
updating the one or more mapping trees with timing information indicative of timings of accesses to the contiguous ranges of addresses related to the physical address space.
